(19) United States
(12) Patent Application Publication
(10) Pub. No.: US 2004/0146285 A1
(43) Pub. Date: Jul. 29, 2004

(54) Moving picture data reproducing device with improved random access

(76) Inventors: Yoshinori Matsui, Ikoma-shi (JP); Youji Notoya, Neyagawa-shi (JP); Tadamasa Toma, Toyonaka-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/475,319

(22) PCT Filed: May 21, 2003
(86) PCT No.: PCT/JP03/06320

(30) Foreign Application Priority Data
May 28, 2002 (JP) 2002-154345
Jul. 10, 2002 (JP) 2002-201989
Jul. 10, 2002 (JP) 2002-201990
Oct. 21, 2002 (JP) 2002-306072

(51) Int. Cl. H04N 5/76

(52) U.S. Cl. 386/98; 375/240.01

(57) ABSTRACT

The moving picture data reproducing device 200 is comprised of file inputting unit 201 for acquiring an MP4 file, data file temporary storage unit 202 that has an area for temporarily storing the accepted input MP4 file, data file analyzing unit 203 for analyzing the file header information by reading the input MP4 file, data decoding unit 204 for reading entity data from data file temporary storage unit 202 based on the analysis result of data file analyzing unit 203 and decoding the entity data, data reproducing unit 205 for reproducing the decoded entity data and outputting the entity data to a displaying device, RA information table generating unit 206 for transforming random access information generated based on the analysis result of data file analyzing unit 203 into a table, file outputting unit 207 for outputting a new MP4 file by integrating the RA information table and the input-completed MP4 file, and file storing unit 208 for storing the outputted MP4 file.

### TECHNICAL FIELD

The present invention relates to a device for reproducing a multiplex file of video data, audio data and the like, and especially a technology for facilitating random access playback such as reproduction position change or fast forward reproduction.

### BACKGROUND ART

Thanks to the recent development of network technology, moving picture data reproducing devices for reproducing moving picture data by downloading files from server devices on wide area network like the Internet have developed. Especially, in these days in which a term of “multimedia” is heavily used, there are many cases where media data such as audio data and text data are contained in files, and moving picture data reproducing devices are required to simultaneously reproduce various tracks such as an audio track and a text track.

This moving picture data reproducing device brings files which includes the coded video data and the like based on a compression coding method such as the MPEG-4 (Moving Picture Experts Group) in the device, and decodes and reproduces the video data and the like. At this time, when there is a mixture of video data, audio data and text data this moving picture data reproducing device separates video data from audio data, synchronizes respective data, and decodes to reproduce the data.

Meanwhile, MP4 file format gains a spotlight as a file format for server devices to distribute files for download. In this Description, an MP4 file format will be explained as an example of file formats.

This MP4 file format was established by MPEG (Moving Picture Experts Group) in 1999. An MP4 file generated based on this MP4 file format that has a hierarchical box structure composed of a plurality of boxes. And coded video data, audio data and the like are multiplexed and stored in the boxes for storing entity data. In an MP4 file accepted by a moving picture data reproducing device, video data, audio data and the like multiplexed in the device are separated from each other and decoded. The processing unit used when a moving picture data reproducing device decodes video data and audio data is called “frame”, respective data are composed of a plurality of frames.

However, the initially established MP4 file format has a problem that it is not suitable for a reproduction method of starting reproduction of moving picture data before a moving picture data reproducing device completes download of an MP4 file, that is, so-called pseudo-streaming playback. The cause of the problem is the feature of the file structure that the file header located in the leading part of the file stores necessary information such as the sizes of respective video frames and audio frames, information for performing multiplexing separation like multiplexing order, necessary information for performing synchronous reproduction of, for example, presentation time information of respective video frames and audio frames all together as to video data and audio data contained in the file.

In other words, the above-mentioned file structure of the initially established MP4 file format makes it impossible to start reproduction of moving picture data contained in the MP4 file until a moving picture data reproducing device finishes downloading the file header part. The initially established MP4 file format also has a problem that the time to download gets longer as the file header size gets bigger. Especially, in the case of a file with long-time data, it takes a lot of time to download the data because of the big file header part, and thus a moving picture data reproducing device needs a lot of time before starting reproduction.

In order to resolve such a problem, a new MP4 file format in which multiplexing separation and synchronous reproduction information, and entity data such as video data and audio data are alternately located has been proposed and the standardization is going on.

FIG. 1 is a diagram showing the structure of the above-mentioned conventional MP4 file format which is now under standardization.

MP4 file 100 is the same as the initially established MP4 file mentioned above in that MP4 file 100 is composed of movie box 101 for storing attribute information (header information) of the whole file such as a coding method of video data and audio data, movie data box 102 for storing entity data of video data and audio data and so on, and movie fragment column 103, and has a hierarchical box structure contains a plurality of boxes, except that MP4 file 100 contains movie fragment column 103.

This movie fragment column 103 contains a repetitive arrangement of movie fragment 104 separated by the prescribed time unit, and called an extension of an MP4 file. On the other hand, the movie box 101 and movie data box 102 mentioned above are called prime data areas of an MP4 file. The above-mentioned prescribed time unit is not always constant, for example, a coding device may adjust the time considering a buffer memory capacity of a decoding device, in this case, as a result, the above-mentioned prescribed time unit may be roughly constant.

Movie fragment 104 is contained in movie fragment box 105 for storing multiplexing separation information and synchronous reproduction information and so on concerning moving picture data contained in the above-mentioned prescribed time unit and so on, and fragment data box 106 for storing entity data of moving picture data contained in the above-mentioned prescribed time unit and so on.

Movie fragment box 105 is a box for storing multiplexing separation information and synchronous reproduction information and so on concerning moving picture data contained in the above-mentioned prescribed time unit and so on and the header information of movie fragment 104. This movie fragment box 105 contains track fragment box 107 for storing multiplexing separation information and synchronous reproduction information on data concerning one track of either a video track or an audio track. In other words, the number of track fragment box 107 contained in movie fragment box 105 is not less than the same number of track types contained in one movie fragment 104, in the case where one movie fragment 104 contains video data and audio data, at least two track fragment box 107 are prepared. “Not less than the same number of track types” used here means that there is a case where a plurality of track fragment box 107 are prepared for one track, for example, there is a case where three track fragment box 107 are prepared in total: two track fragment box 107 for storing multiplexing separation information and synchronous reproduction information concerning a video track, and one track fragment box 107 for storing multiplexing separation information and synchronous reproduction information concerning an audio track.

This track fragment box 107 contains a plurality of track run box 108 separated by a smaller unit than the prescribed time unit mentioned above, track run box 108 is further contains a plurality of entry 109.

Entry 109 is a group of fields for writing information on frames as processing unit in decoding, that is, multiplexing separation information and synchronous reproduction information. In track run box 108 contained in track fragment box 107 concerning video tracks, information for indicating whether a video frame is an intra coded frame (a so-called intra frame) or not may be present in the field of entry 109. Generally, there are many cases where video data has the structure with these intra frames repetitively arranged per certain number of video frames, one unit repetitively arranged like this structure is called GOP (Group Of Picture). And, it is assumed that entry 109 is contained in track run box 108 by the GOP unit.

Also, a synchronous sample flag may be set to 1 in this entry 109 in order to perform synchronous reproduction among respective data, in this case, synchronous sample flag information is present in the field of the entry 109, this description means that information for indicating that the video frame is an intra frame is stored.

Fragment data box 106 is a box for storing entity data of the frame specified in the corresponding movie fragment box 105, and samples that consists of frames are stored there.

Each of these boxes consists of MP4 file 100 is composed of box header part 110 and box data storing part 111. In box header part 110, at least box size 112 for storing information on box sizes and box type 113 for storing letter strings for identifying box types are contained. Also, in box data storing part 111, one or more subordinative boxes may be contained, or one or more fields storing information may be contained.

In this way, movie fragment column 103 has the structure of a repetitive arrangement of movie fragment 104 contained in movie fragment box 105 for storing multiplexing separation information and synchronous reproduction information concerning video data and audio data separated by the prescribed time unit, and fragment data box 106 for storing corresponding entity data. In other words, in the initially established MP4 file mentioned above, all of multiplexing separation information, synchronous reproduction information and the like is stored in the movie box without being separated by the prescribed time unit, all of entity data are stored in the movie data box, that is why the size of movie box 101 for storing the header information gets bigger as mentioned before, and there occurs a problem that it takes long time to catch the starting part of movie data box 102 storing video data and audio data. In order to resolve this problem, in this MP4 file, movie fragment column 103 as an extension is established to make it possible to store large part of video data and audio data there, reduce the size of movie box 101, and shorten the time to start reproduction.

However, there is a problem that, when using the MP4 file format with a file structure mentioned above, it is difficult to have a moving picture data reproducing device perform random access. “Random access” used here means a processing function such as moving a reproduction position to the position of 10 seconds later, and performing fast forward reproduction. This problem will be further explained.

At the time of performing random access, the moving picture data reproducing device is required to receive a request for random access playback from a user through a user interface, immediately determine the reproduction starting position (decoding starting position) of video data and the like contained in an MP4 file according to the request, decode and reproduce the video data and so on.

Also, video data and the like generated by highly efficient compression coding method such as the MPEG-4 are usually composed of video frames of intra frames and inter coded frames (so-called predictive frames). As this predictive frame is a frame for decoding with reference to the data of video frames decoded, setting a predictive frame as the reproduction starting position with random access makes it impossible to reproduce correctly, and there occurs some troubles like distortion of reproduced pictures. Therefore, an intra frame must be set as the reproduction starting position with random access.

Therefore, for example, when a random access request for moving a reproduction position to the position of 10 seconds later is inputted, a moving picture data reproducing device must analyze movie fragment box 105 storing all the video frames including the video frame under decoding, the video frame that will be under decoding 10 seconds later, and the video frames in between, further analyze each of track fragment box 107 including video data, and then further analyze each of track run box 108. After analyzing great many boxes up to very small unit in this way, the moving picture data reproducing device must count reproduction duration, and determine the video frame of 10 seconds forward that is the reproduction starting position after performing random access. Also, the moving picture data reproducing device must judge whether the video frame of 10 seconds forward is an intra frame or not. When it is not an intra frame, the moving picture data reproducing device must find the nearest intra frame to use it as the video frame of reproduction starting position after performing random access.

In this way, in the conventional MP4 file format, the heavy workload of the moving picture data reproducing device at the time of performing random access results in taking long time for the moving picture data reproducing device to determine the reproduction starting position after performing random access, and finally results in a problem of having to make users wait for the time.

And, in the conventional MP4 file format, it is impossible to change the reproduction position to the part which is not fully downloaded while it is possible to change the reproduction position to the part which has fully been downloaded because one of the purposes of the conventional MP4 file format is to utilize the file format for pseudo-streaming playback for reproducing video frames downloading from server devices on the Internet. Therefore, it is assumed that random access in reproducing the data of the MP4 file is often used when replaying after a moving picture data reproducing device downloads and reproduces the MP4 file first.

As it is also assumed that the conventional MP4 file format is used in download distribution, it is desired to reduce the size of the MP4 file in view of telephone time and fees. Especially, as to mobile communication system in which fees are determined in proportion to the amount of data downloaded, there is a problem that the file size must be minimized as much as possible so that the telephone fees should not be comparatively expensive.

Therefore, the present invention is made considering these problems and circumstances aiming at providing a moving picture data reproducing device that can immediately perform random access processing of files multiplexed by video data, audio data and the like without extending the size of the files to be downloaded.

### DISCLOSURE OF INVENTION

In order to achieve the above-mentioned purpose, the moving picture data reproducing device in the present invention for reproducing a file contains video data and at least one of audio data and text data are multiplexed, the moving picture data reproducing device comprises a file inputting unit operable to put the file into the moving picture data reproducing device, a file temporary storage unit with an area for storing the file temporarily, a file analyzing unit operable to analyze the file header information for separation and synchronous reproduction of the video data, audio data, or text data contained in the input file after reading the input file stored in the file temporary storage unit, a decoding unit operable to read and decode the video data, audio data or text data contained in the input file stored in the file temporary storage unit, based on the file header information analyzed by the file analyzing unit, a reproducing unit operable to reproduce the video data, audio data or text data decoded by the decoding unit and output the data on a displaying device, a random access information generating unit operable to generate random access information for random access to the video data, audio data or text data based on the file header information analyzed by the file analyzing unit, a reproduction position controlling unit operable to output an analysis position change order for changing analysis position of the input file to the file analyzing unit with reference to the random access information generated by the random access information generating unit. The file analyzing unit changes the reading position of the input file stored in the file temporary storage unit based on the analysis position change order outputted by the reproduction position controlling unit, and analyzes the file header information on the video data, audio data or text data contained in the input file.

Thanks to these features, this device can realize quick random access playback because the device generates information indicating the position of the header information, that is, random access information, on the independently decodable frames at the time of the first file reproduction.

The random access information generating unit can generate the random access information respective for media data contained in the input file here. By doing so, in the case where various kinds of tracks are multiplexed in an input file, the effectiveness of quick random access processing is executed by referring to the random access information for each track.

Also, the moving picture data reproducing device in the present invention comprises a file outputting unit operable to output files which contains the random access information generated by the random access information generating unit, the random access information generating unit generates the first hierarchical layer for writing the random access information for respective media data contained in the input file and the second hierarchical layer into which the first hierarchical layer is integrated when the input file has a hierarchical box structure, and it is desirable that the file outputting unit output files with the random access information by integrating the second hierarchical layer into the input file.

In this way, as the random access information which is generated at the time of first file reproduction being outputted as a file, it is possible to realize a device that can contribute to quickening random access playback at the time of next reproduction.

Moreover, the file outputting unit can generate the position information indicating the starting position of the second hierarchical layer integrated into the input file, integrate the position information into the input file, and output files with the random access information.

In this case, it is possible to quickly read the part in which random access information is stored, which leads to faster random access playback.

Note that the present invention can be implemented as a moving picture data reproduction method in which the characteristic units of this moving picture data reproducing device are used as steps and as a program having the computer execute these steps beside as a moving picture data reproducing device. In the case of such a program, it is needless to say that the program can be distributed via a storage medium such as a CD-ROM and a transmission medium such as the Internet.

Further Information about Technical Background to this Application

The following applications are incorporated herein by reference.

Japanese Patent Application No. 2002-154345 filed May 28, 2002.

Japanese Patent Application No. 2002-201989 filed Jul. 10, 2002.

Japanese Patent Application No. 2002-201990 filed Jul. 10, 2002.

Japanese Patent Application No. 2002-306072 filed Oct. 21, 2002.

### BRIEF DESCRIPTION OF DRAWINGS

These and other objects, advantages and features of the invention will become apparent from the following description thereof taken in conjunction with the accompanying drawings that illustrate a specific embodiment of the invention. In the Drawings:

FIG. 1 is a diagram showing the file structure of the conventional MP4 file.

FIG. 2 is a block diagram showing the structure of the moving picture data reproducing device concerning a first embodiment in the present invention.

FIG. 3 is a diagram showing the file structure of the MP4 file generated by the moving picture data reproducing device concerning the first embodiment in the present invention.

FIG. 4 is a flow chart showing a processing procedure by which the moving picture data reproducing device concerning the first embodiment in the present invention generates a random access information table.

FIG. 5 is a diagram showing the random access information table. FIG. 5A is a diagram showing the data contained in the table, and FIG. 5B is a diagram showing the data structure of the table.

FIG. 6 is a diagram showing the file structure of the MP4 file generated by the moving picture data reproducing device concerning a first variation of the first embodiment in the present invention.

FIG. 7 is a block diagram showing the structure of the moving picture data reproducing device concerning a second variation of the first embodiment in the present invention.

FIG. 8 is a block diagram showing the structure of the moving picture data reproducing device concerning a third variation of the first embodiment in the present invention.

FIG. 9 is an illustration showing the relation between the MP4 file and the random access information table. FIG. 9A is a diagram showing the file generated by the moving picture data reproducing device concerning the first embodiment in the present invention. FIG. 9B is a diagram showing the file generated by the moving picture data reproducing device concerning the second variation of the first embodiment in the present invention. FIG. 9C is a diagram showing the file generated by the moving picture data reproducing device concerning the third variation of the first embodiment in the present invention.

FIG. 10 is a block diagram showing the structure of the moving picture data reproducing device concerning a second embodiment in the present invention.

FIG. 11 is a block diagram showing the structure of the moving picture data reproducing device concerning the first variation of the second embodiment in the present invention.

FIG. 12 is a block diagram showing the structure of the moving picture data reproducing device concerning the second variation of the second embodiment in the present invention.

FIG. 13 is a block diagram showing the structure of the moving picture data reproducing device concerning a third embodiment in the present invention.

FIG. 14 is a diagram showing the file structure of the third embodiment in the present invention.

FIG. 15 is an illustration showing random access processing by the moving picture data reproducing device concerning the third embodiment in the present invention. FIG. 15A is an illustration showing a first processing method. FIG. 15B is an illustration showing a second processing method.

FIG. 16 is a flow chart showing the processing procedure of the moving picture data reproducing device based on FIG. 15A.

FIG. 17 is a diagram showing the file structure of the MP4 file generated by the moving picture data reproducing device concerning a fourth embodiment in the present invention.

FIG. 18 is a flow chart showing an acquirement procedure of random access information by the moving picture data reproducing device concerning the fourth embodiment in the present invention.

FIG. 19 is an illustration showing an acquirement procedure of random access information by the moving picture data reproducing device concerning the fourth embodiment in the present invention. FIG. 19A is an illustration showing a first acquirement procedure. FIG. 19B is an illustration showing a second acquirement procedure.

FIG. 20 is a diagram showing an applied example of the moving picture data reproducing device concerning the present invention.

### BEST MODE FOR CARRYING OUT THE INVENTION

The embodiments of the present invention will be further explained below with reference to figures.

(First Embodiment)

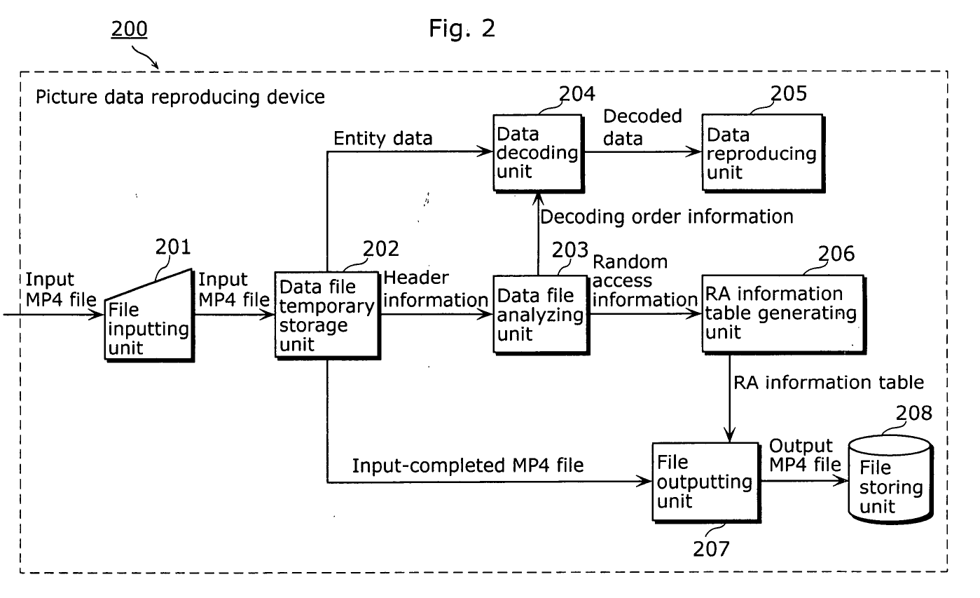

FIG. 2 is a block diagram showing the structure of the moving picture data reproducing device concerning the first embodiment in the present invention.

This moving picture data reproducing device 200 is a device for decoding and reproducing video data, audio data and the like coded by a compression coding method such as MPEG-4, and the device has file inputting unit 201 for accepting the MP4 file in the device, data file temporary storage unit 202 for storing the MP4 file accepted in the device temporarily, data file analyzing unit 203 for reading out and analyzing the header information of the MP4 file, data decoding unit 204 for decoding entity data contained in the MP4 file, data reproducing unit 205 for reproducing and outputting the entity data decoded to a displaying device such as a display, random access information table (called “RA information table” below) generating unit 206 for generating an RA information table in order to perform random access quickly, file outputting unit 207 for outputting a new MP4 file by multiplexing the input-completed MP4 file and the RA information table, and file storing unit 208 for storing the outputted MP4 file.

File inputting unit 201 is a processing unit operable to download and accept an MP4 file stored in a server device on the Internet in the moving picture data reproducing device, and the unit is implemented by a communication interface and the like for communicating with a server via the Internet and the like. This file inputting unit 201 accepts the MP4 file by downloading it from the file head in order, and the unit has data file temporary storage unit 202 store the file in order.

Data file temporary storage unit 202 is a storing unit operable to temporarily storing the MP4 file accepted by file inputting unit 201, and the unit is implemented by a storing device such as a RAM (Random Access Memory), a hard disc or the like.

Data file analyzing unit 203 is a processing unit operable to read and analyze the header information of the MP4 file stored in data file temporary storage unit 202, and the unit is implemented by a CPU and a memory. The file header information of the MP4 file said here means the header information of the whole file contained in the movie box and the movie fragment header information of multiplexing separation information, synchronous reproduction information and the like contained in the movie fragment box. Also, this data file analyzing unit 203 outputs decoding order information necessary for decoding video data and the like such as information on the frame interface position and presentation time to data decoding unit 204 based on the result of MP4 file header information analysis. Furthermore, this data file analyzing unit 203 outputs random access information (called “RA information” below) to RA information table generating unit 206 based on the result of the MP4 file header information analysis.

Data decoding unit 204 is a processing unit operable to read and decode the entity data such as video data, audio data and the like in the MP4 file stored in data file temporary storage unit 202 based on a decoding order information accepted from data file analyzing unit 203, and the unit is implemented by a decoder with a CPU and a memory.

Data reproducing unit 205 is a unit operable to reproduce and output the entity data which is decoded by data decoding unit 204 to a displaying device such as a display or a speaker, the unit is implemented by a microprocessor such as a DSP (Digital Signal Processor), a chip with a VRAM (Video Random Access Memory), or a video card and the like.

RA information table generating unit 206 is a processing unit operable to generate RA information table based on RA information accepted from data file analyzing unit 203, the unit is implemented by a CPU and a memory. RA information said here is position information and time information concerning the header information of frames to be the reproduction starting positions after random access, and RA information table is a table of integrated RA information. Further explanation for RA information and an RA information table will be made later.

File outputting unit 207 is a processing unit operable to read the MP4 file stored in data file temporary storage unit 202 after download, that is the MP4 file inputted to the device, accept an RA information table from RA information table generating unit 206 and adding the RA information table to the end of the input-completed MP4 file, and multiplex the input-completed MP4 file and the RA information table to output a new MP4 file, and the unit is implemented by a CPU and a memory.

File storing unit 208 is a storing unit operable to store the MP4 file outputted by file outputting unit 207, and the unit is implemented by a storage device such as a hard disc, a magneto-optic disc, a storage medium and the like such as an SD memory card.

Here, the structure of the MP4 file outputted by this moving picture data reproducing device 200 will be explained.

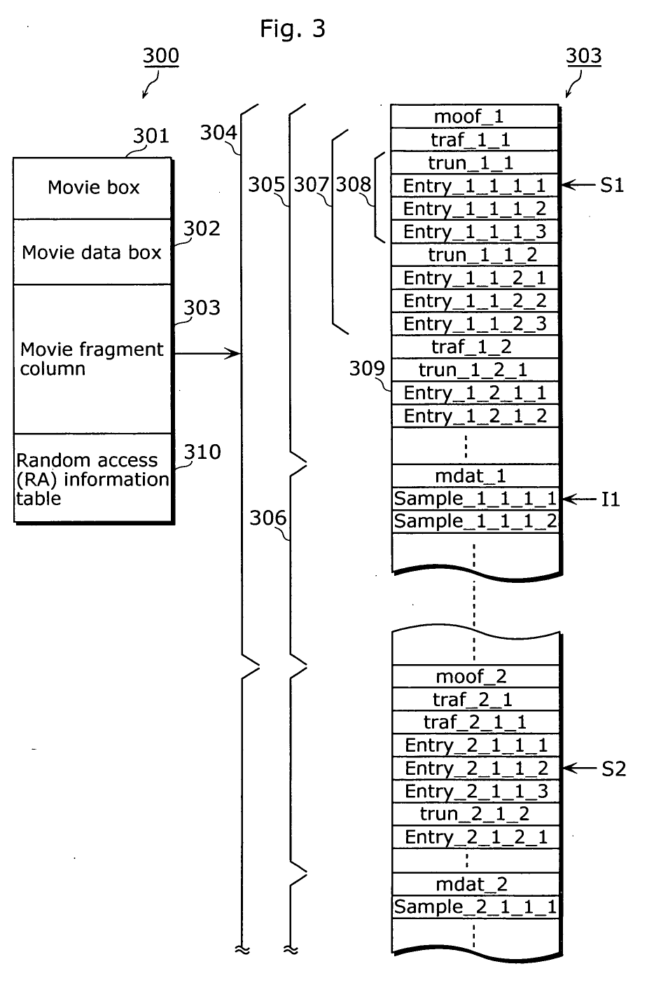

FIG. 3 is a diagram showing the file structure of the MP4 file generated by moving picture data reproducing device 200 concerning this first embodiment.

As shown in FIG. 3, MP4 file 300 generated by moving picture data reproducing device 200 is composed of movie box 301, movie data box 302, movie fragment column 303 and RA information table 310, and MP4 file 300 is different from the conventional MP4 file 100 in that, chiefly, MP4 file 300 has RA information table 310.

This MP4 file 300 is generated in a way that movie box 301, movie data box 302, and movie fragment column 303 of the MP4 file 300 are accepted by the moving picture data reproducing device 200 through file inputting unit 201 in order, and then part of RA information table 310 is added in file outputting unit 207 of the moving picture data reproducing device 200.

In other words, an MP4 file inputted to moving picture data reproducing device 200 has the same structure as the conventional MP4 file 100 at a stage of being accepted by file inputting unit 201 of moving picture data reproducing device 200.

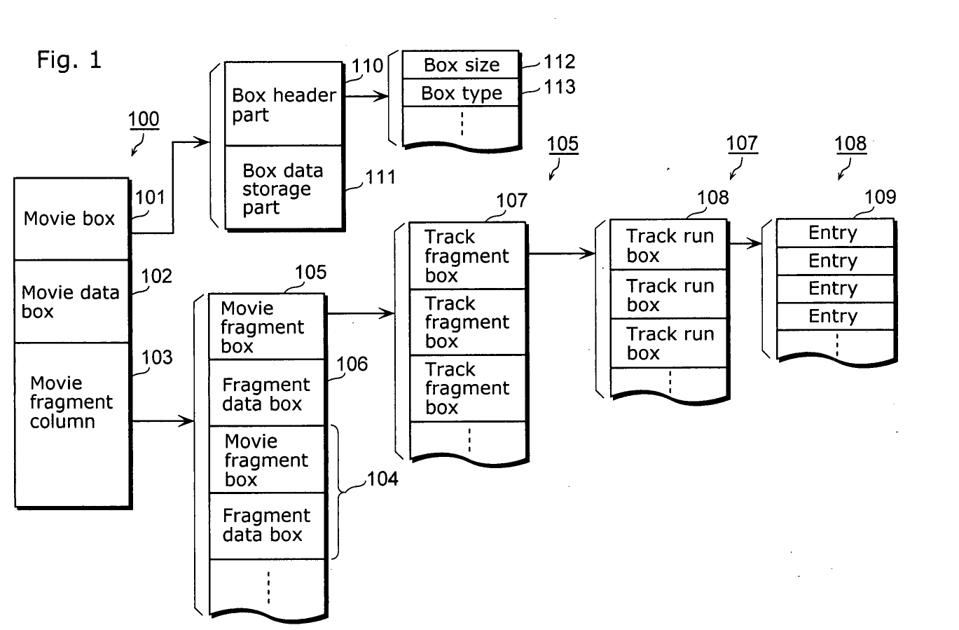

In order to explain the generating process of this MP4 file 300, FIG. 3 specifically shows a hierarchical box structure contains the fragment column 303 unlike FIG. 1.

Movie fragment column 303 is a plurality of movie fragment 304 repetitively arranged, and movie fragment 304 contains an alternate arrangement of movie fragment box 305 and fragment data box 306. Letter strings of “moof” indicating the type of movie fragment box 305 is contained in the box header part of movie fragment box 305, which identifies that this box is a movie fragment box 305. Also, information on the size of this box is stored in the place just before the letter strings indicating this type although the information is not stored in the figure. Besides “moof”, the number indicating the ordinal position of each movie fragment box 305 from the head of the file is contained in the box header part of the movie fragment box 305.

Also, Letter strings of “traf” indicating the type of track fragment box 307 is contained in the box header part of track fragment box 307 contained in the box data storage part of movie fragment box 305, which identifies that this box is a track fragment box 307. Also, information on the size of this box is stored in the place just before the letter strings indicating this type. Track number information of the track is contained in the box header part of track fragment box 307, which identifies each track. As explained before, track fragment box 307 is one kind of header data, the pointed data is stored in fragment data box 306. In other words, information indicating the ordinal position of a track fragment box 307 stored in movie fragment box 305 is not indicated, and moving picture data reproducing device 200 counts the number of track fragment box 307 each time it appears.

Letter strings of “trun” indicating the type of track run box 308 is contained in the box header part of track run box 308 contained in the box data storage part of track fragment box 307, and information on the size of this box is stored in the place just before the letter strings indicating this type. Also, in the field of entry 309 contained in the box data storage part of track run box 308, display duration information of the minimum unit such as video data and audio data pointed by the entry 309 and information for indicating whether a frame is an intra frame or not is contained. There is a case where a file making device stores default value of synchronous sample flag information concerning the whole video sample in movie box 301, and that a file making device stores default value of synchronous sample flag information and duration length information concerning a sample contained in the box in track fragment box 307.

Information indicating that the sample is an intra frame is stored in the field of track run box 308 when the first entry 309 contained in track run box 308 indicates that the sample is an intra frame, while synchronous sample flag information for each of the present entry 309 in the field of entry 309 when the sample pointed by entry 309 is a synchronous frame.

Letter strings of “mdat” indicating the type of fragment data box 306 is contained in the box header part of fragment data box 306, which indicates that this box is fragment data box 306. Information on the size of this box is stored in the place just before the letter strings indicating this type. Also, samples constitute frames indicated by each entry 309 contained in movie fragment box 305 are contained in the box data storage part of fragment data box 306 in entry order.

In FIG. 3, synchronous sample flag S1 is present in the first entry 309 in the first track run box 308 contained in the first track fragment box 307 in the first movie fragment box 305, and synchronous sample flag S2 is present in the second entry 309 in the first track run box 308 contained in the first track fragment box 307 in the second movie fragment box 305. Therefore, synchronous sample flag information on synchronous sample flag S1 is present in the field of the first track run box 308, and synchronous sample flag information on synchronous sample flag S2 is present in the field of the set Entry 309. Also, synchronous sample flag S1 indicates that the first sample contained in the first fragment data box 306 is intra frame 11.

In other words, the header information of frames to be the reproduction starting positions after random access are stored in entry 309 including these synchronous sample flags, and thus moving picture data reproducing device 200 integrates position information and time information on these entry 309 and generates RA information table 310.

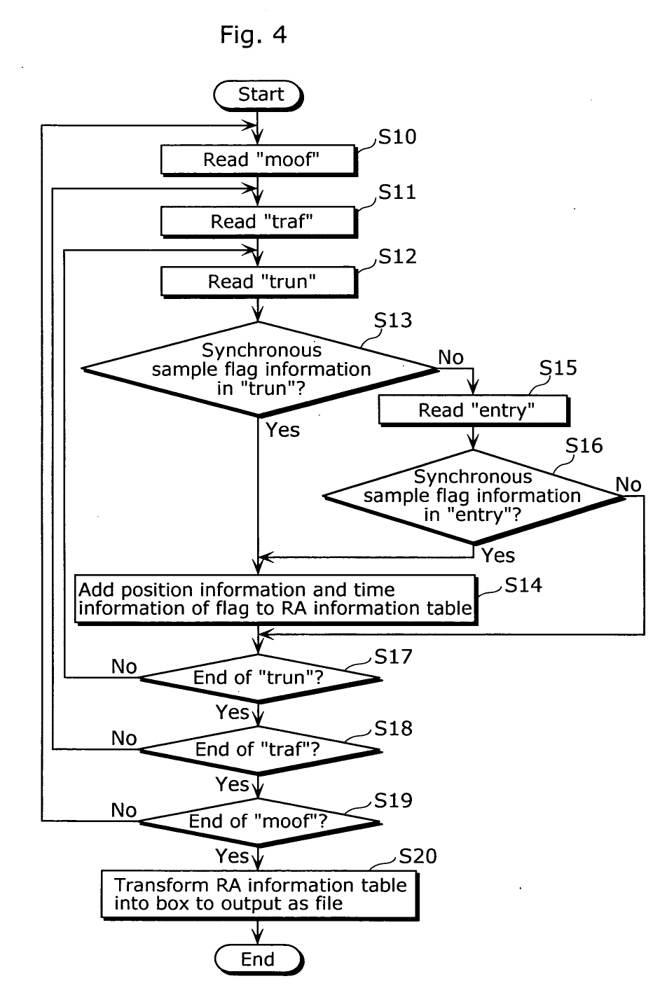

The generating process of RA information table 310 will be explained below with reference to FIG. 4.

FIG. 4 is a flow chart showing the processing procedure by which the moving picture data reproducing device concerning this first embodiment generates an RA information table.

First, data file analyzing unit 203 reads the first movie fragment box 305 contained in movie fragment 304 (S10), and next the first track fragment box 307 contained in the movie fragment box 305 (S11). Data file analyzing unit 203 proceeds to the subordinative layer of the box hierarchy and reads the first track run box 308 contained in the first track fragment box 307 (S12).

Data file analyzing unit 203 analytically judges whether synchronous sample flag information is present in the field of this track run box 308 (S13).

When synchronous sample flag information is present in the field of this track run box 308, data file analyzing unit 203 outputs position information and time information of the synchronous sample flag as RA information to RA information table generating unit 206, and RA information table generating unit 206 adds this information to RA information table 310 (S14).

On the other hand, when synchronous sample flag information is not present in the field of track run box 308, data file analyzing unit 203 proceeds to the subordinative layer of the box hierarchy and reads entry 309 contained in the first track run box 308 one by one (S15).

Data file analyzing unit 203 analytically judges whether synchronous sample flag information is stored in the field of entry 309 read one by one (S16).

When synchronous sample flag information is present in the field of entry 309, like the case where synchronous sample flag information is present in the field of track run box 308 mentioned before, RA information table generating unit 206 adds position information and time information of synchronous sample flags outputted as RA information by data file analyzing unit 203 to RA information table 310 (S14).

On the other hand, when synchronous sample flag information is not present in the field of entry 309, as well as when position information and time information of synchronous sample flag as RA information is sent to RA information table generating unit 206 and the information is added to RA information table 310, data file analyzing unit 203 reads next track run box 308.

When track fragment box 307 contains track run box 308, moving picture data reproducing device 200 repeats the procedure of S12˜S14. When track fragment box 307 does not contain track run box 308, data file analyzing unit 203 reads next track fragment box 307 (S17).

Likewise, when movie fragment box 305 contains track fragment box 307, moving picture data reproducing device 200 repeats the procedure of S11˜S17. When movie fragment box 305 does not contain track fragment box 307, data file analyzing unit 203 reads next movie fragment box 305 (S18).

After that, with next movie fragment box 305, moving picture data reproducing device 200 repeats the procedure of S11˜S18. Without next movie fragment box 305, RA information table generating unit 206 receives RA information end information from data file analyzing unit 203, and outputs the generated RA information table 310 to file outputting unit 207 (S19). Finally, RA information table 310 is transformed into a box structure by file outputting unit 207 and combined with the end of the input-completed MP4 file to be outputted as a part of a new MP4 file 300 (S20).

As mentioned above, when default value of synchronous sample flag information on the whole movie sample is stored in movie box 301 and default value of synchronous sample flag information and duration length information on the samples are stored in track fragment box 307, moving picture data reproducing device 200 gets these default values and stores them in the memory. If track run box 308 is omitted, moving picture data reproducing device 200 refers to track fragment box 307 and then movie box 301, and it generates RA information table 310 using these default values.

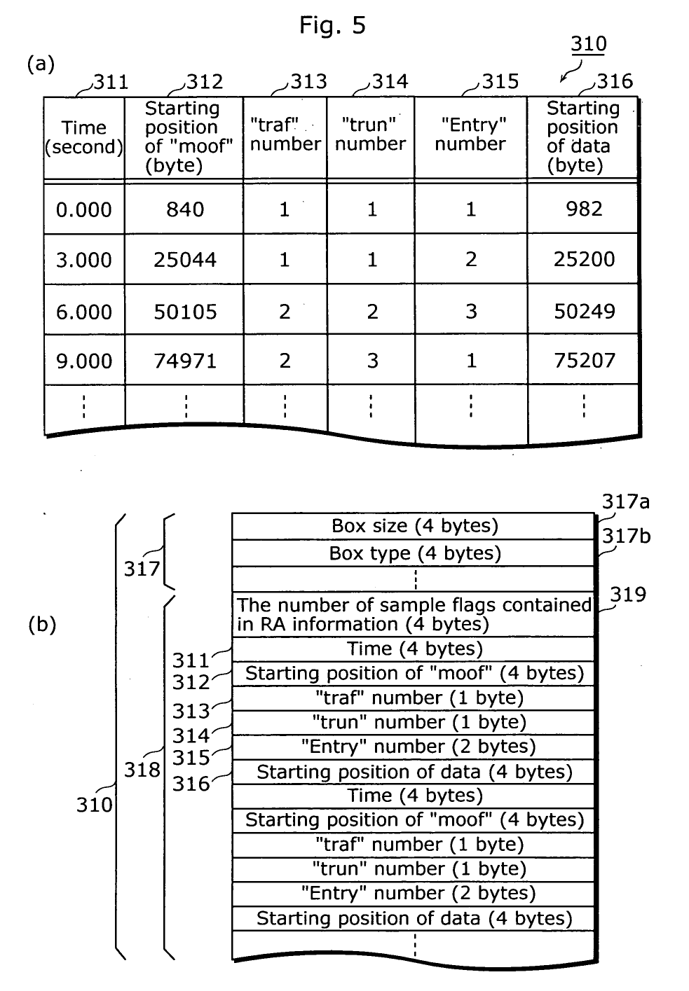

Information and data structure contained in RA information table 310 generated in this process will be explained below with reference to FIG. 5.

FIG. 5A is a diagram showing the data contents of RA information table 310.

RA information table 310 has same number of lines as the number of RA information stored in the table, and has a structure in which a piece of RA information is written per line. Each line provides the location and the presentation time of the random accessible sample and it is just called “RA entry”.

A line of RA information (RA entry) is composed of following fields: Time 311 for indicating presentation time of the frame pointed by the RA entry with synchronous sample flag information, starting position of “moof” 312 giving the byte offset between the beginning of the file and the beginning of the “moof” which contains entry 309, “traf” number 313 indicating the ordinal position of the track fragment box 307 whose box type is “traf” and which contains entry 309 in each “moof” 312, “trun” number 314 indicating the ordinal position of the track run box 308 whose box type is “trun” and which contains in entry 309 in each “traf”, entry number 315 indicating the ordinal position of entry 309 of its kind in each “trun”, data starting position 316 giving the byte offset of the sample pointed by entry 309.

FIG. 5B is a diagram showing the data structure of RA information table 310.

As mentioned above, RA information table 310 is transformed into a box structure by file outputting unit 207 (S20 in FIG. 4).

RA information table 310 transformed into a box structure contains box header part 317 and box data storage part 318 like other boxes contained in MP4 file 300. Box header part 317 contains at least box size 317a for storing box size information and box type 317b for storing letter strings for identifying box type, and for example, 4 bytes is allocated to these fields respectively. This box header part 317 can store version flag information for indicating the version and the flag information of RA information table 310.

Sample flag number 319 contained in RA information table for indicating the number of RA information contained in RA information table 310 is contained in box data storage part 318 located next to box header part 317, and next to sample flag number 319, fields of 311˜316 compose RA information are lined up. Explanation is made on assumption that the following data lengths are allocated to the following fields: 4 bytes to the field of sample flag number 319, as to fields that compose this RA information, 4 bytes to time 311, 4 bytes to starting position of “moof” 312, 1 byte to “traf” number 313, 1 byte to “trun” number 314, 2 bytes to entry number 315, 4 bytes to starting position of data 316. However, shorter data lengths can be allocated so as to reduce data amount or RA information table 310 can store the information indicating data lengths.

In this way, moving picture data reproducing device 200 concerning this first embodiment extracts position information and time information on header information of frames to be reproduction starting positions with random access such as intra frames when reproducing the file at the first file reproduction stage, that is, the stage for downloading and reproducing the MP4 file. Moving picture data reproducing device 200 integrates position information and the like and adds the information to the end of the MP4 file after finishing download and outputting a new MP4 file. In other words, as moving picture data reproducing device 200 generates and outputs information for performing random access quickly in the first file reproduction stage, the device can contribute to quickening random access playback in reproduction after download.

Next, the first variation of this first embodiment will be explained.

In the above-mentioned first embodiment in moving picture data reproducing device 200, data file analyzing unit 203 outputs RA information to RA information table generating unit 206 where RA information tables are generated.

By contrast, in the first variation, in a moving picture data reproducing device with a very similar structure to the device used in the above-mentioned first embodiment, data file analyzing unit outputs RA information respective for tracks to RA information table generating unit like RA information for a video track and RA information for an audio track, and RA information tables for respective tracks are generated in RA information generating unit.

Therefore, the structure of the MP4 file generated by a moving picture data reproducing device concerning the first variation differs from the MP4 file generated by moving picture data reproducing device 200 mentioned above. The structure of the MP4 file generated by the moving picture data reproducing device concerning the first variation and the generating process will be explained below.

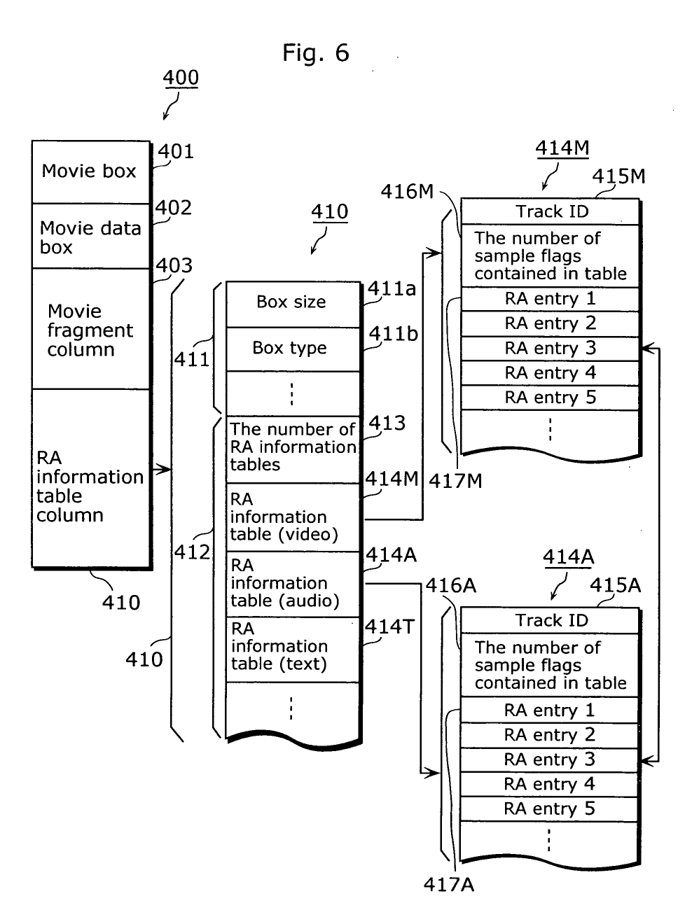

FIG. 6 is a diagram showing the file structure of the MP4 file generated by the moving picture data reproducing device concerning the first variation of this first embodiment.

This MP4 file 400 composes movie box 401, movie data box 402, movie fragment column 403 and RA information table column 410, and the file differs from the above-mentioned MP4 file 300 in that MP4 file 400 contains a plurality of RA information tables.

The structure of this MP4 file 400 is the same as that of the conventional MP4 file 100 at the time of being accepted into a moving picture data reproducing device.

RA information table column 410 is transformed to be a box structure that contains a plurality of RA information tables repetitively arranged. In other words, this RA information table column 410 contains box header part 411 and box data storage part 412 like other boxes of the MP4 file 400. Box header part 411 placed at the head of RA information table column 410 contains at least box size 411a for storing size information of box and box type 411b for storing letter strings for indicating box types, and for example, 4 bytes is allocated to these fields respectively. Version flag information for indicating version and flag information of RA information table column 410 can be contained in this box header part 411.

RA information table number 413 for indicating the number of RA information table contained in RA information table column 410 is contained in box data storage part 412 placed next to box header part 411, and for example, RA information tables generated for respective tracks such as RA information table for video track 414M, RA information table for audio track 414A and RA information table for text track 414T are contained in the box data storage part 412.

The structures of RA information tables generated for respective tracks can be the same regardless of track type or vary from track type to track type. Explanation will be made on assumption that the structure of RA information tables are the same regardless of track types, with reference to RA information table for video track 414M and RA information table for audio track 414A.

RA information table for video track 414M is a table with integrated RA information on a video track. The head of this RA information table for video track 414M contains track ID 415M that is a field for writing unique letter strings indicating for which track the RA information table is. The field of sample flag number 416M is contained in the table follows this track ID 415M, and next to it, RA entry 417M is placed. RA entry 417M means a group of fields that contains integrated fields of “time 311”˜“starting position of data 316” in RA information table 310 in the above-mentioned first embodiment.

On the other hand, RA information table for audio track 414A is a table that integrates RA information on an audio track. This RA information table for audio track 414A contains track ID 415A at the head like RA information table for video track 414M. Sample flag number 416A contained in the table that follows this track ID 415A, and next to it, RA entry 417A is placed.

As shown in FIG. 6, RA information table 414M and 414A are generated so that synchronous reproduction of a pair of same-order RA entries such as RA entry 417M in RA information table for video track 414M and RA entry 417A in RA information table for audio track 414A can be performed.

Also, generally, in the case of audio tracks, the data of decoded frames are not referred to when audio tracks are decoded unlike the data of predictive frames in video tracks and any audio frame can be a starting position of decoding and reproducing. That is why information added to the table is not always limited to “entry” indicating that the sample is an intra frame. Therefore, for example, there can be a rule that the interval of reproduction time of audio frames is constant, and RA information on audio tracks should be time information and position information on header information of audio frames placed according to the rule.

Otherwise, there can be a rule that the audio frame of reproduction time nearest to the reproduction time value stored in the field of RA entry 417M in RA information table for video track 414M by tuning reproduction time of video frames to that of audio frames. As the sample rate of a video frame is different from that of an audio frame, the reproduction time of a video frame is not always the same as that of an audio frame. However, according to this rule, it is possible to write approximate reproduction time and the starting position of “moof” respectively in RA entry 417M and 417A for reference, and roughly synchronize the reproduction starting time of video data with that of audio data after random access even when there is a time lag between the reproduction time of a video frame and that of an audio frame.

Furthermore, RA information on an audio track can be time information and position information on header information of audio frames reproduced synchronously to video frames.

In other words, after sample flag number 416A contained in RA information table for audio track 414A, for example, it is possible to place a field for indicating reproduction time of an audio frame arranged according to a prescribed rule, a field for indicating position information of the header corresponding to audio frames reproduced synchronously to video frames, or an alternate arrangement of these fields.

In this way, as the moving picture data reproducing device concerning the first variation can generate MP4 file 400 contains RA information tables for respective tracks like an RA information table for a video track and an RA information table for an audio track, the device can contribute to quickening random access playback in reproduction after download even when various kinds of tracks are multiplexed in the MP4 file accepted by the device.

Next, the second and the third variations of this first embodiment will be explained below.

In the first embodiment mentioned above, moving picture data reproducing device 200 generates MP4 file 300 by adding RA information table 310 to the end of the MP4 file accepted by the device. By contrast, in the second variation, an MP4 file and an RA information table file are made separately from the MP4 file accepted in the device.

Therefore, the components of the moving picture data reproducing device in the second variation differ from those of the moving picture data reproducing device 200 mentioned above. Explanation for the moving picture data reproducing device in the second variation is made mainly focusing on the difference between the device and the moving picture data reproducing device 200.

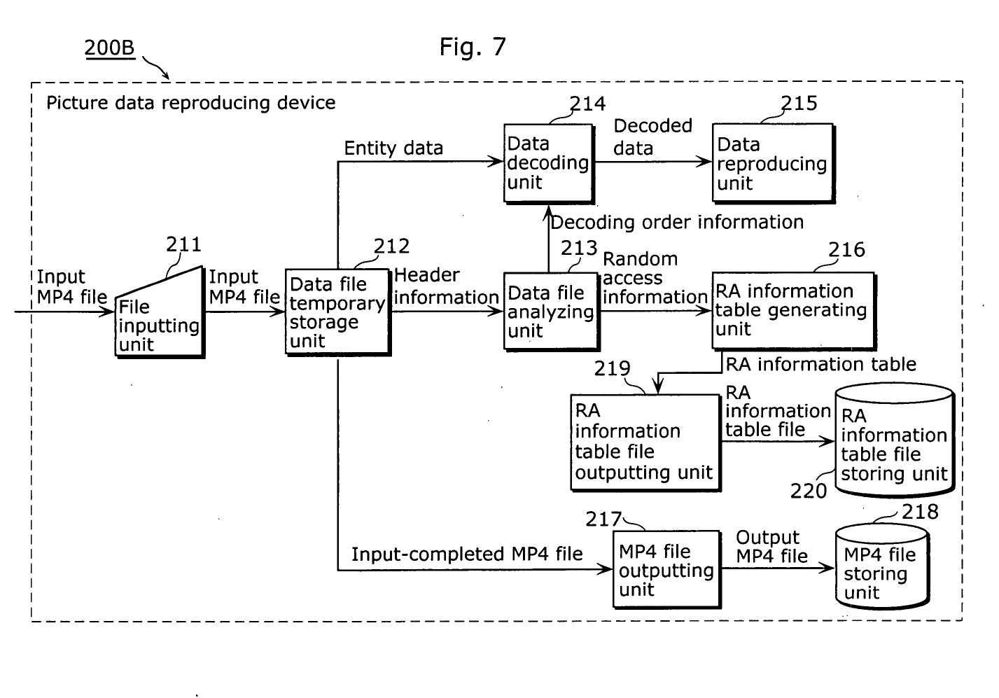

FIG. 7 is a diagram showing the structure of the moving picture data reproducing device in the second variation in this first embodiment.

The moving picture data reproducing device 200B in this second variation differs from the moving picture data reproducing device 200 mainly in that it is equipped with RA information table file outputting unit 219 and RA information table file storing unit 220.

RA information table file outputting unit 219 is a unit operable to accept RA information table outputted by RA information table generating unit 216, transform RA information into a box structure and then into a file, and output an RA information table file. The unit is implemented by a CPU and a memory.

RA information table file storing unit 220 is a storing unit operable to store an RA information table file outputted by RA information table file outputting unit 219, and the unit is implemented by a storing device such as a hard disc, a magneto-optic disc, a storage medium such as an SD memory card.

Thanks to this structure, moving picture data reproducing device 200B can generate an RA information table file and an MP4 file separately, which makes it possible to resend an MP4 file to be stored in MP4 file storing unit 218 to another moving picture data reproducing device and so on keeping the file size minimum. Also, the application area of the RA information table file can be expanded, for example, by copying only RA information table file to another moving picture data reproducing device using an easily portable storage medium such as a flexible disc.

As there is a need for indicating the relation between an RA information table file and MP4 file to be outputted, it is advisable to prescribe a rule for indicating the relation, for example, by giving the RA information table file same file name as the MP4 file with a different extension and to output the RA information table file according to the rule in RA information table file outputting unit 219. More specifically, for example, when an extension for indicating that the file is an MP4 file is “.mp4” and an extension for indicating that the file is an RA information table file is “.rat”, it is advisable to output the MP4 file as “aaa.mp4” and the RA information table file as “aaa.rat”

Unlike this, in the third variation, an RA information table file, an MP4 file, and an association management file are generated from an input MP4 file.

Therefore, the components of the moving picture data reproducing device in the third variation differ from those of the moving picture data reproducing device 200B. Explanation for the moving picture data reproducing device in the third variation is made mainly focusing on the difference between the device and the moving picture data reproducing device 200B.

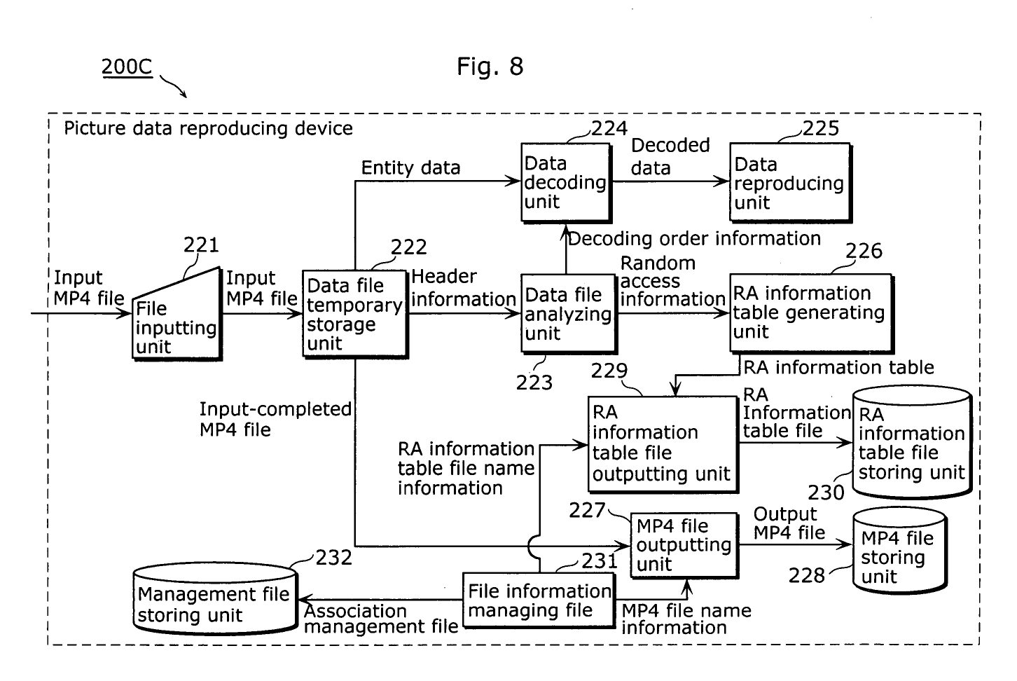

FIG. 8 is a block diagram showing the structure of the moving picture data reproducing device in the third variation in this first embodiment.

This moving picture data reproducing device 200C in the third embodiment differs from the moving picture data reproducing device 200B mainly in that moving picture data reproducing device 200C is equipped with file information managing unit 231 and management file storing unit 232.

File information managing unit 231 is a unit operable to decide the names of an MP4 file and an RA information table file to be outputted according to a file name order inputted in the moving picture data reproducing device 200C by a user via an input device such as a keyboard, output MP4 file name information to MP4 file outputting unit 227, output RA information table file name information to RA information table file outputting unit 229, and transform the rule for associating both files into a file to output the file as an association management file. File information managing unit 231 is implemented by a CPU and a memory.

Management file storing unit 232 is a storing unit operable to store the association management file outputted by file information managing unit 231, and the unit is implemented by a storing device such as a hard disc, a magneto-optic disc, a recording medium such as an SD memory card.

Thanks to the structure, moving picture data reproducing device 200C can generate an independent file concerning the rule for associating both files when generating an RA information table file and an MP4 file separately, and thus a user can decide the file name.

In this way, there are a plurality of patterns of associating an MP4 file with an RA information table generated by the moving picture data reproducing device in this first embodiment and its variations.

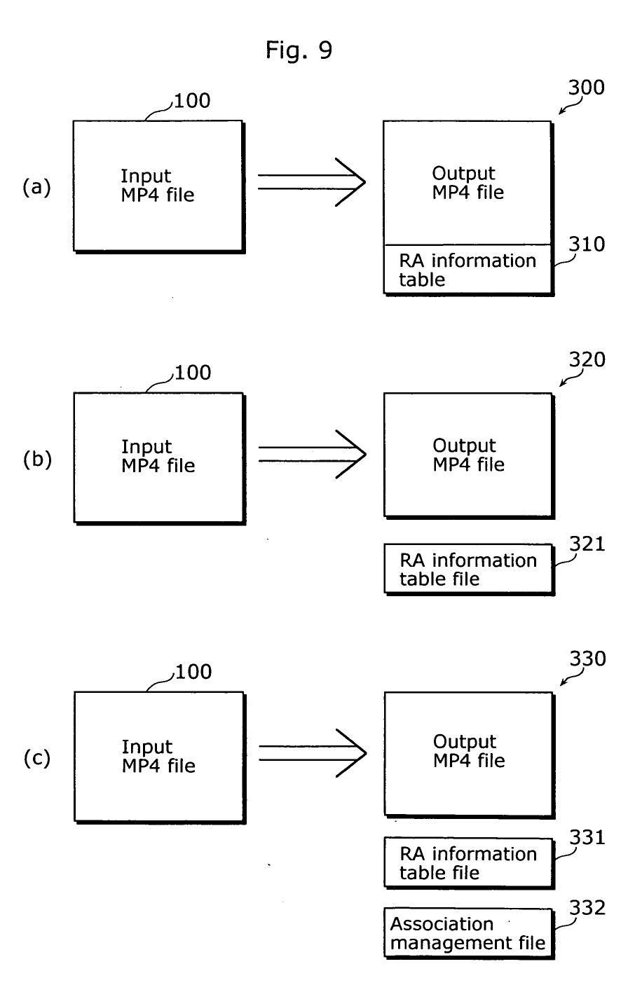

FIG. 9A˜9C are diagrams showing the association of an MP4 file and an RA information table.

FIG. 9A is a diagram showing a file generated by moving picture data reproducing device 200 in this first embodiment. By using moving picture data reproducing device 200 in this first embodiment, when MP4 file 100 with a structure shown in FIG. 1 is accepted by the device, RA information table 310 is added to the end of the file, and the file is outputted as a new MP4 file 300 into which RA information table 310 is integrated.

FIG. 9B is a diagram showing a file generated by moving picture data reproducing device 200B in the second variation. By using moving picture data reproducing device 200B, when MP4 file 100 with a structure shown in FIG. 1 is accepted by the device, MP4 file 320 with very similar structure to that of MP4 file 100 shown in FIG. 1 is outputted, and separately, RA information table file 321 is outputted. In this case, as mentioned above, the name of RA information table file 321 is decided according to the prescribed rule for associating it with output MP4 file 320.

FIG. 9C is a diagram showing a file generated by moving picture data reproducing device 200C in the third variation. By using moving picture data reproducing device 200C, when MP4 file 100 with a structure shown in FIG. 1 is accepted by the device, MP4 file 330 with very similar structure to that of MP4 file 100 shown in FIG. 1 is outputted, and separately, RA information table file 331 and association management file 332 are outputted. In this case, association management file 332 associates RA information table file 331 with output MP4 file 330 as mentioned above, and thus association management file 332 has a role for mediating RA information table file 331 and output MP4 file 330.

As explained above, moving picture data reproducing devices in the first embodiment and the variations generate information for performing random access quickly at the time of first file reproduction, and thus the devices can contribute to quickening random access playback.

(Second Embodiment)

Next, the second embodiment in the present invention will be explained with reference to figures.

While explanation for a moving picture data reproducing device for generating RA information table in order to quicken random access processing is made in the first embodiment mentioned above, explanation for a moving picture data reproducing device for utilizing the generated RA information table will be made in this second embodiment. Therefore, the components of the moving picture data reproducing device in this second embodiment differ from those of moving picture data reproducing device 200 in the first embodiment. The difference is focused on in the following explanation.

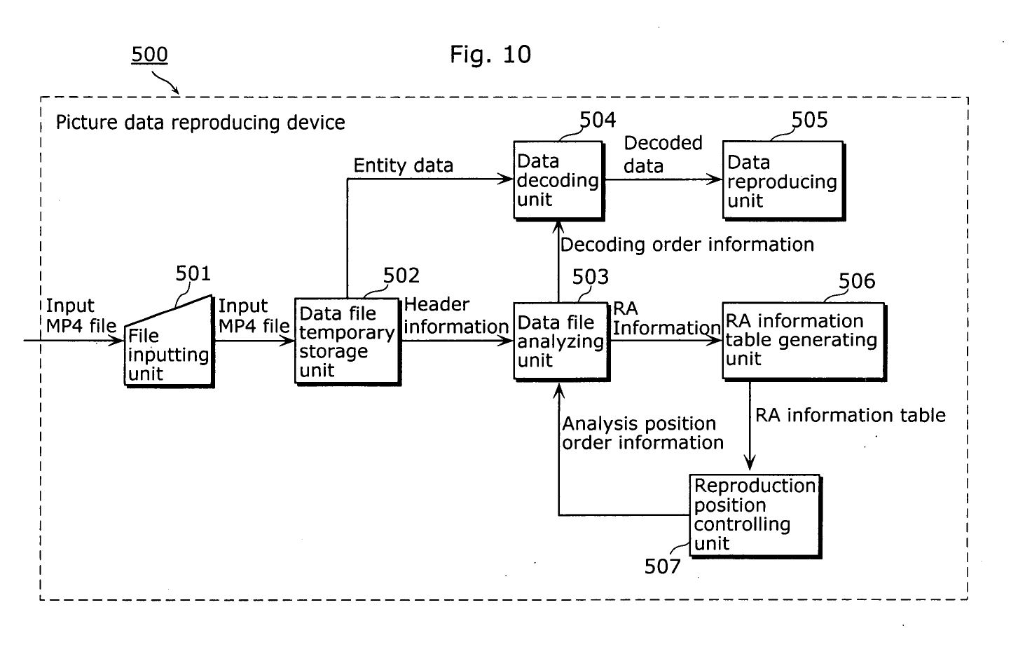

FIG. 10 is a block showing the structure of the moving picture data reproducing device in the second embodiment in the present invention.

This moving picture data reproducing device 500 is equipped with reproduction position controlling unit 507, and the device differs from moving picture data reproducing device 200 in the first embodiment in that the moving picture data reproducing device 500 does not have either a file outputting unit or a file storing unit.

Reproduction position controlling unit 507 is a unit operable to output analysis position order information for ordering reproduction positions after random access, and reproduction position controlling unit 507 is implemented by a CPU and a memory. According to a reproduction position change order (random access order) to moving picture data reproducing device 500 inputted by a user via an input device such as a keyboard or a mouse, this reproduction position controlling unit 507 decides reproduction positions after random access with reference to an RA information table and outputs analysis position order information to data file analyzing unit 503.

Unlike the first embodiment, data file analyzing unit 503 analyzes the header information of the MP4 file according to the analysis position order information and outputs decoding order information to data decoding unit 504 based on the result.

Also, it is possible to have RA information table generating unit 506 generate and output an RA information table by integrating all of RA information, it is desirable to have the unit integrate a prescribed number of RA information and then generate and output RA information tables placed at a prescribed interval in order so that the unit can utilize RA information during the download reproduction.

As moving picture data reproducing device 500 with this structure does not output RA information table as a file, it is possible to perform random access while an MP4 file is being downloaded and reproduced or the downloaded MP4 file is stored in data file temporary storage unit 502. This is for the case where outputting a downloaded MP4 file to the external storing device of moving picture data reproducing device 500 is prohibited, and when an MP4 file in data file temporary storage unit 502 is deleted, the corresponding RA information table is also abandoned. As there is no data in the undownloaded part of an MP4 file, it is impossible to jump to the part with random access. However, it is possible to jump to the downloaded part with random access even while the MP4 file is being downloaded and reproduced.

In this way, on reproducing a file in the first file reproduction stage, moving picture data reproducing device 500 in the second embodiment generates an RA information table where position information and time information and the like on the header information of frames to be reproduction starting points with random access, the device performs random access playback with reference to the information described in this table, and thus the device can realize quick random access playback.

Next, the first variation in the second embodiment will be explained.

In the second embodiment mentioned above, in moving picture data reproducing device 500, neither the generated RA information table nor the MP4 file after download is outputted as a file.

By contrast, in the first variation, in the moving picture data reproducing device, the generated RA information table and the MP4 file after download are outputted as a file.

Therefore, the components of the moving picture data reproducing device in the first variation differ from those of the moving picture data reproducing device 500. The difference will be focused on in the following explanation for moving picture data reproducing device 500 in the first variation.

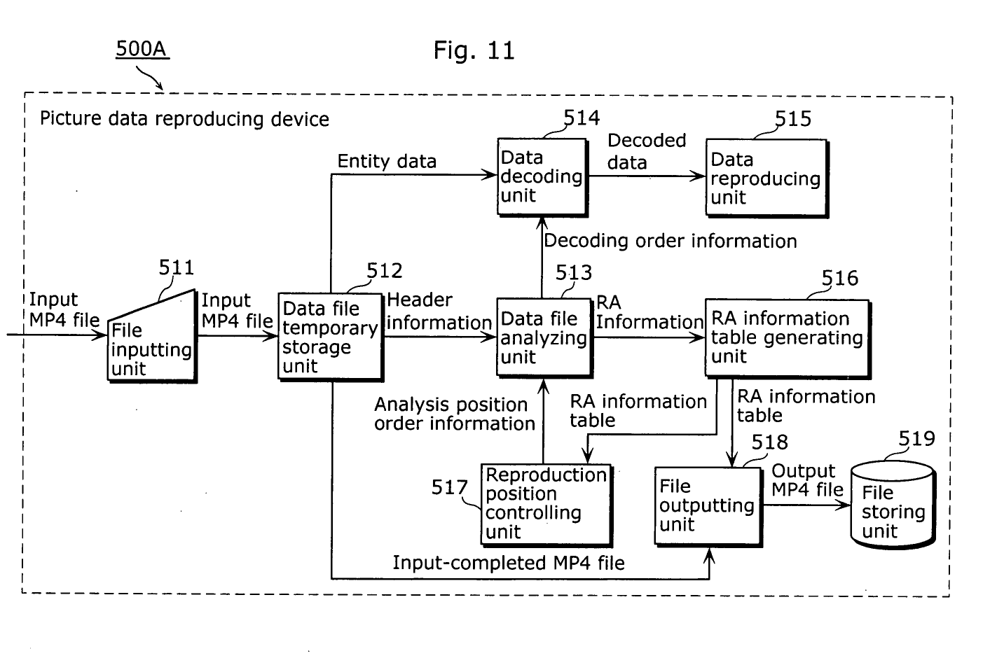

FIG. 11 is a block showing the structure of the moving picture data reproducing device in the first variation in the second embodiment.

This moving picture data reproducing device 500A differs from moving picture data reproducing device 500 in the second embodiment mentioned above mainly in that moving picture data reproducing device 500A is equipped with a file outputting unit 518 and a file storing unit 519.

File outputting unit 518 is a unit operable to read the MP4 file inputted in the device, receive the RA information table with all of RA information integrated from RA information table generating unit 516, add RA information to the end of the input MP4 file, multiplex the input MP4 file and the RA information table to output a new MP4 file, and file outputting unit 518 is implemented by a CPU and a memory.

File storing unit 519 is a storing unit operable to store the MP4 file outputted by file outputting unit 518, and the unit is implemented by a storage medium such as a hard disc, a magneto-optical disc, a recording medium such as an SD memory ca rd.

And, RA information table generating unit 516 integrates a prescribed number of RA information, generates RA information tables at a prescribed interval in order to output the information to reproduction position controlling unit 517, and integrates RA information to output an RA information table with all of RA information integrated to file outputting unit 518 like RA information table generating unit 506 in the moving picture data reproducing device 500 mentioned above.

RA information table generating unit 516 can integrate a prescribed number of RA information, generate RA information tables at a prescribed interval in order to output the information to reproduction position controlling unit 517, and file outputting unit 518 can generate an RA information table with all of RA information integrated and add the information to the end of the input-completed MP4 file.

The structure of an RA information table to be generated is the same as RA information table 310 in the above-mentioned first embodiment or RA information table 410 in the first variation in the above-mentioned first embodiment.

In this way, moving picture data reproducing device 500A in the first variation can realize quick random access playback because the device generates an RA information table in which position information and time information on the header information of frames to be reproduction starting positions with random access and performs random access playback using the information stored in the table when reproducing the file at the first file reproducing stage. Also, as the device can output information for performing quick random access playback as a file after finishing download, the device can contribute to quickening random access playback even after an MP4 file is deleted in data file temporary storage unit 512 after downloading the MP4 file unlike in the second embodiment.

Next, the second variation in the second embodiment will be explained.

In the first variation in the second embodiment mentioned above, RA information tables are generated in moving picture data reproducing device 500 and 500A.

By contrast, in the second variation, the moving picture data reproducing device does not generate any RA information table because the device reads RA information tables already generated to use them for random access playback.

Therefore, the components of the moving picture data reproducing device in the second variation differ from those of moving picture data reproducing device 500 and 500A mentioned above. The difference will be focused on in the following explanation for the moving picture data reproducing device in the second variation.

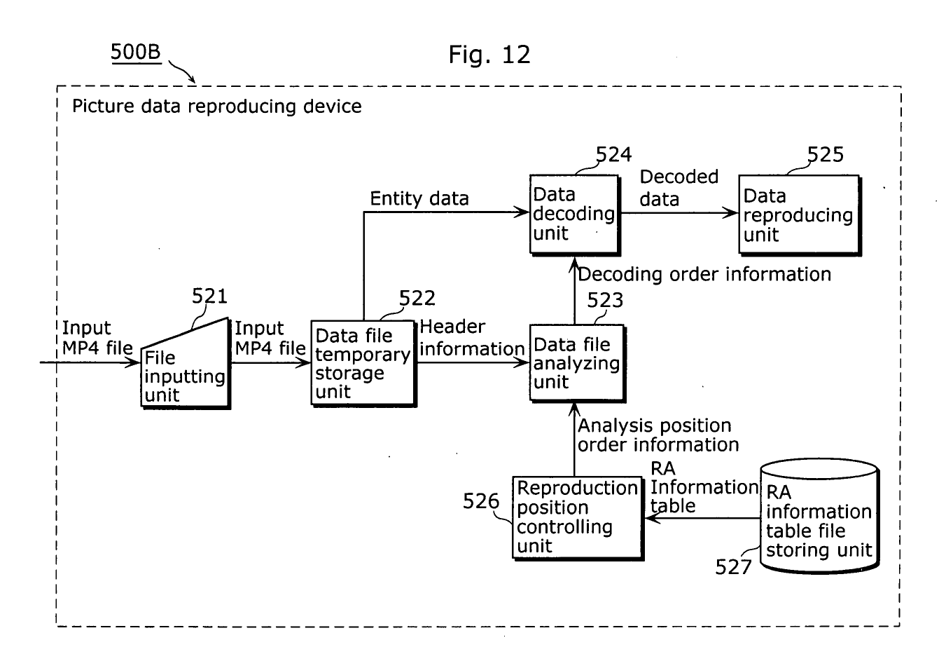

FIG. 12 is a block showing the structure of the moving picture data reproducing device in the second variation in the second embodiment.

This moving picture data reproducing device 500B differs from moving picture data reproducing device 500 and 500A in the second embodiment and the first variation mentioned above mainly in that moving picture data reproducing device 500B is equipped with RA information table file storing unit 527, but is not equipped with an RA information table generating unit and so on.

RA information table file storing unit 527 is, for example, a storing unit operable to store the RA information table file already generated in moving picture data reproducing device 200B and so on in the second variation in the first embodiment mentioned above, and the unit is implemented by a storing device such as a hard disc or an easily portable recording medium and so on such as an SD memory card and a flexible disc.

Reproduction position controlling unit 526 follows the random access order from a user inputted in moving picture data reproducing device 500B via an inputting device such as a keyboard or a mouse, reads RA information tables from RA information table file storing unit 527, with reference to the information, decides reproduction positions with random access, and outputs analysis position order information to data file analyzing unit 523.

Thanks to the structure of moving picture data reproducing device 500B, there is no need to generate RA information tables when an RA information table file concerning the MP4 file to be downloaded and reproduced has been already generated, and thus it is possible to quicken random access playback. In this case, it is possible to jump to only the downloaded part with random access, because there are no data of the undownloaded part in the MP4 file even though the RA information file includes all of RA information.

As explained up to this point, the moving picture data reproducing device in the second embodiment or its variations generates information for performing quick random access when reproducing the first file and reads information already generated to use the information, and thus the device can perform quick random access playback.

(Third Embodiment)

Next, the third embodiment in the present invention will be explained with reference to figures.

Explanation for the moving picture data reproducing device that generates RA information tables is mainly made in the first embodiment mentioned above, and explanation for the moving picture data reproducing device that uses RA information tables is mainly made in the second embodiment mentioned above. In other words, in order to realize quick random access, a moving picture data reproducing device that transforms RA information tables into a box structure or that uses the RA information table generated in a box structure is explained in the first and the second embodiments mentioned above.

By contrast, a moving picture data reproducing device in the third embodiment generates boxes for storing RA information for respective tracks and a box for storing these boxes all in one. Therefore, the components of the moving picture data reproducing device in the third embodiment differ from those of a moving picture data reproducing device in the first and the second embodiments mentioned above. The difference will be focused on in the following explanation.

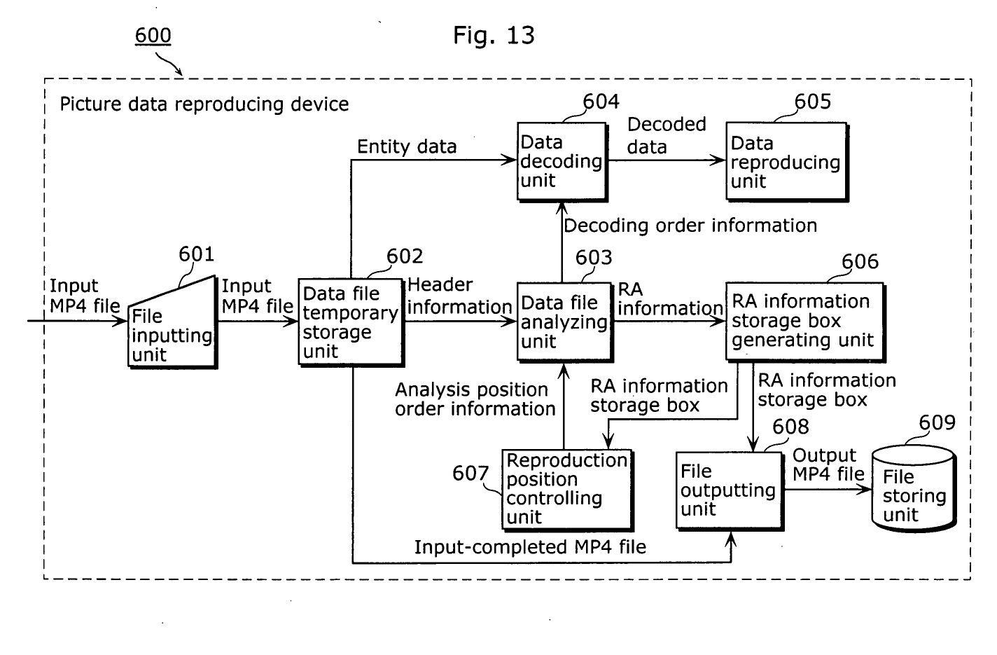

FIG. 13 is a block diagram showing the structure of the moving picture data reproducing device in the third embodiment in the present invention.

This moving picture data reproducing device 600 differs from the moving picture data reproducing device in the first and the second embodiments mentioned above mainly in that moving picture data reproducing device 600 is equipped with RA information storage box generating unit 606.

RA information storage box generating unit 606 is a unit operable to receive RA information from data file analyzing unit 603, and generate track RA information storage boxes for storing RA information for respective tracks, the unit is implemented by a CPU, a memory and so on. Detailed explanation for this track RA information storage boxes and an RA information storage box will be made later on.

Reproduction position controlling unit 607 follows the random access order from a user inputted in moving picture data reproducing device 600 via an inputting device such as a keyboard or a mouse, reads an RA information box from RA information storage box generating unit 606, with reference to the information, decides reproduction positions with random access, and outputs analysis position order information to data file analyzing unit 603.

Also, file outputting unit 608 reads the MP4 file inputted to the device, receives an RA information storage box from RA information storage box generating unit 606, integrates the input-completed MP4 file and the RA information storage box, and outputs a new MP4 file.

Reproduction position controlling unit 607 can read the in-process RA information storage boxes in RA information storage box generating unit 606 for making it possible to use RA information storage boxes while downloading and reproducing the MP4 file.

Next, explanation for the structure of the MP4 file to be generated by this moving picture data reproducing device 600 will be made.

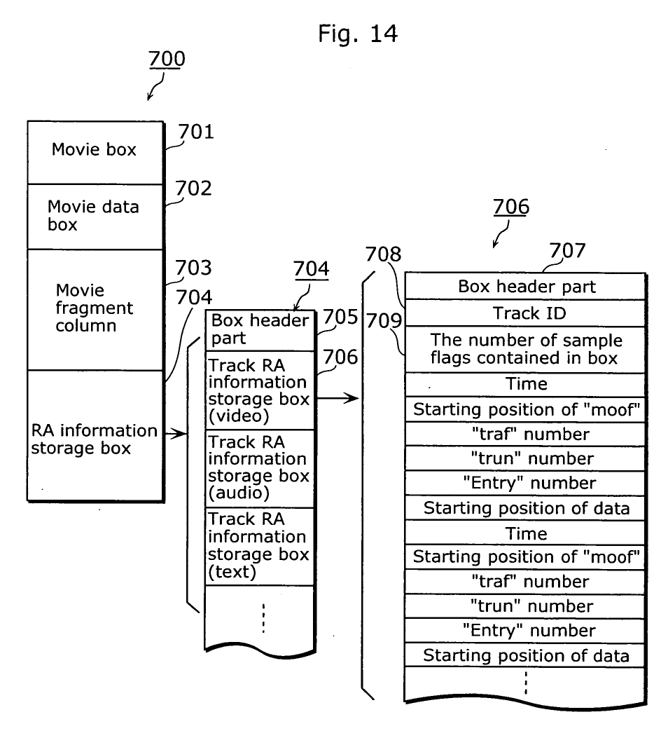

FIG. 14 is a diagram showing the file structure of the MP4 file to be generated by moving picture data reproducing device 600 in the third embodiment in the present invention.

As shown in FIG. 14, this MP4 file 700 is composed of movie box 701, movie data box 702, movie fragment column 703 and RA information storage box 704, and the file differs from the MP4 file 300 in that MP4 file 700 contains RA information storage box 704.

This MP4 file 700 has the same structure as the conventional MP4 file 100 at the stage of being accepted by moving picture data reproducing device 600.

RA information storage box 704 is a box for storing track RA information storage box 706 all in one, the box contains box header part 705 and box data storage parts, and a plurality of track RA information storage box 706 are contained in the box data storage parts.

The box header part 705 of this RA information storage box 704 contains at least a field of box size for storing size information for RA information storage box 704 and a field of box type for storing letter strings of, for example, “mfra” as letter strings for indicating the box type of RA information storage box 704. Also, this box header part 705 can include version flag information for indicating the version and flag information of RA information storage box 704 or a field for storing information for indicating the number of track RA information storage box 706 contained in the box. For example, 4 bytes is assigned to respective fields.

Track RA information storage box 706 is a box for storing RA information for respective tracks such as a video track RA information storage box and the like, like other boxes of MP4 file 700, track RA information storage box 706 contains box header part 707 and box data storage parts where track ID 708, sample flag number 709 contained in the box and a plurality of RA information are stored.

Box header part 707 of this track RA information box 706 contains at least a field of box size for storing size information on track RA information storage box 706 and a field of box type for storing, for example, letter strings of “tfra” as letter strings for identifying box type of track RA information storage box 706.

The box data storing part of track RA information storage box 706 is composed of a field of track ID 708 for which track the RA information is, a field of sample flag number 709 contained in a box for indicating the number of RA information in track RA information storage box 706, and a field for composing RA information.

A field of track ID 708 and sample flag number 709 contained in the box can be contained in box header part 707, and also, version flag information on track RA information storage box 706 can be contained in box header part 707.

The field composing RA information has the same structure as the ones shown in the cases of the first and the second embodiments mentioned above, and the assigned bytes are fixed length. Meanwhile, For example, 4 bytes is assigned to respective fields in track RA information storage box 706 except fields composing RA information.

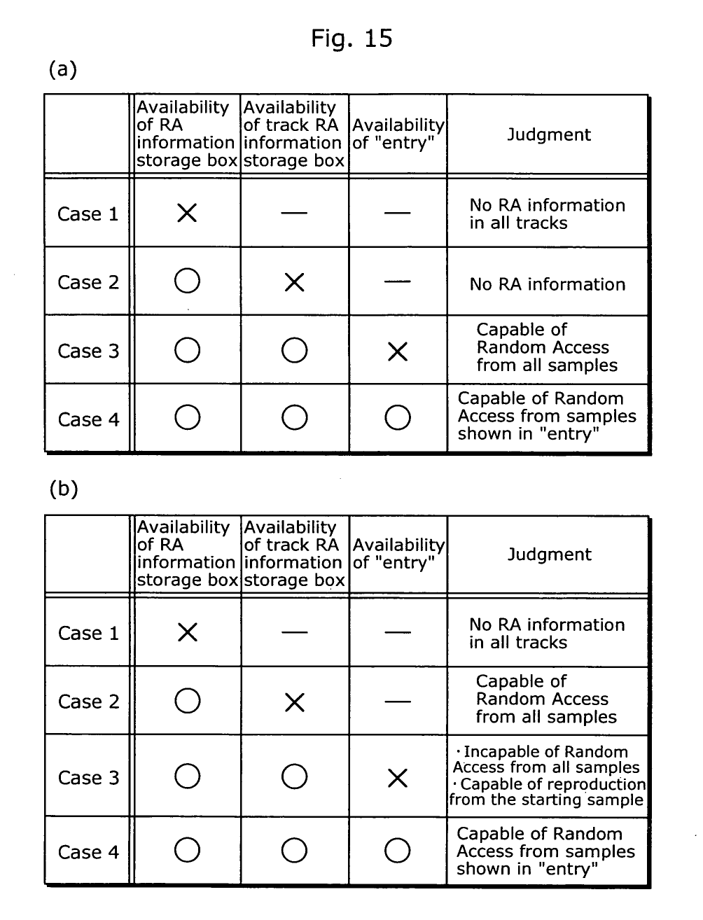

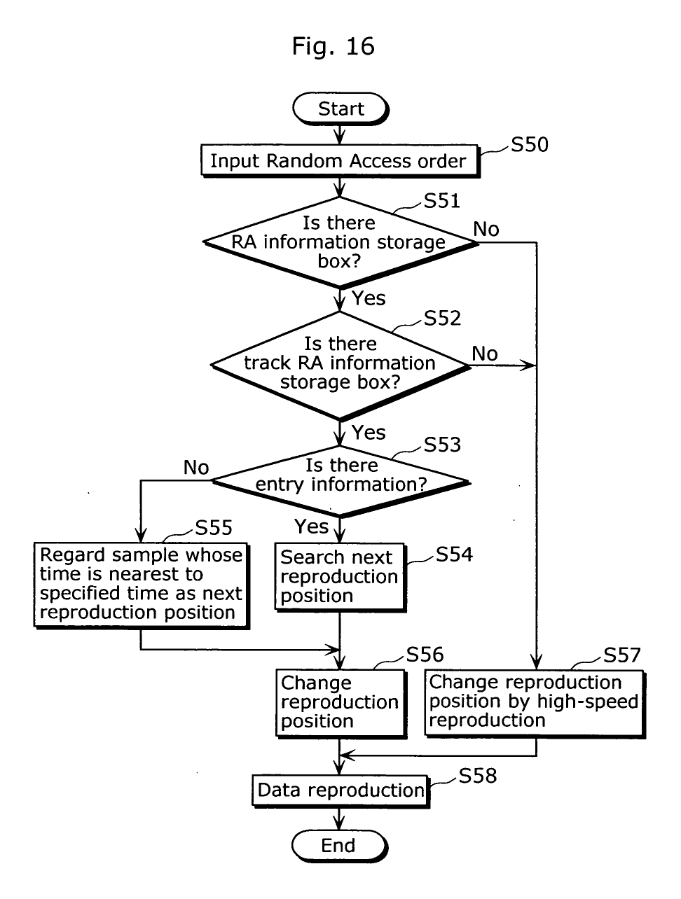

Explanation for the method for random access playback by moving picture data reproducing device 600 will be made here with reference to FIG. 15 and FIG. 16.

FIG. 15A is an illustration showing the first method for random access playback by moving picture data reproducing device 600 in the third embodiment, and FIG. 16 is a flow chart showing the processing procedure of the moving picture data reproducing device based on FIG. 15A.

First, as shown in FIG. 16, when reproduction position controlling unit 607 of moving picture data reproducing device 600 receives input of a random access order from a user (S50), the device tries to read an RA information storage box from RA information storage box generating unit 606 (S51).

This time, when there is no RA information storage box in RA information storage box generating unit 606, that is in the case of Case 1 shown in FIG. 15A, reproduction position controlling unit 607 judges that RA information on all tracks is not contained in MP4 file. Therefore, reproduction position controlling unit 607 orders data file analyzing unit 603 to output an order for moving reproduction positions by high-speed reproduction (S57). Moving reproduction positions by high-speed reproduction here means that analyzing the header information of an MP4 file, counts the reproduction duration decoding frames one by one, and moving to frames to be reproduction starting positions after random access like the conventional reproduction position change, but at a faster reproducing speed than usual.

After that, data file analyzing unit 603 outputs decoding order information on reproduction positions after change to data decoding unit 604, and data reproducing unit 605 reproduces the entity data decoded by data decoding unit 604 (S58). In this case, as the reproduction position after change is not always an intra frame, it is impossible to get any assurance that data reproduction after change can be decoded properly. To avoid improper decoding, it is possible to maintain usual reproduction speed giving up using random access function.

On the other hand, when there is an RA information storage box in RA information storage box generating unit 606, reproduction position controlling unit 607 tries to read track RA information storage boxes contained in an RA information storage box (S52). This time, when there is no track RA information storage box in RA information storage box, that is, in the case of Case 2 shown in FIG. 15A, reproduction position controlling unit 607 judges that RA information on all tracks is not contained in MP4 file. Therefore, reproduction position controlling unit 607 outputs an order for moving reproduction positions by high-speed reproduction to data file analyzing unit 603 (S57).

After that, data file analyzing unit 603 outputs decoding order information on reproducing position after change to data decoding unit 604, and data reproduction unit 605 reproduces the entity data decoded by data decoding unit 604 (S58).

By contrast, when there is a track RA information storage box, reproduction position controlling unit 607 tries to read the entry information contained in a track RA information storage box (S53).

When there is no entry at this point, that is, in the case of Case 3 shown in FIG. 15A, reproduction position controlling unit 607 judges that it is possible to perform random access from all the samples concerning the track. Therefore, reproduction position controlling unit 607 outputs a reproduction position change order to data file analyzing unit 603 in order to specify the sample whose time is nearest to the time specified by the random access order as the reproduction starting position (S55). Data file analyzing unit 603 counts the reproduction duration of the frames contained in the header information of the MP4 file, specified the sample whose time is nearest to the time specified by the random access order as the reproduction position after change (S56), and outputs decoding order information to data decoding unit 604.

After that, data decoding unit 604 decodes the entity data, and data reproducing unit 605 reproduces the decoded entity data (S58). In this case, it is possible to perform random access from any of samples, and thus proper decoding and reproducing of the data after change is assured.

On the other hand, when there is entry information, that is, in the case of Case 4 shown in FIG. 15A, reproduction position controlling unit 607 judges that random access can be performed only from the sample shown in the entry information.

Therefore, reproduction position controlling unit 607 searches entry information corresponding to the time specified by a random access order in a track RA information storage box, decides reproduction starting positions after random access, and outputs analysis position order information to data file analyzing unit 603 (S54).

After that, data file analyzing unit 603 outputs decoding order information to data decoding unit 604 based on the analysis position order information, data reproducing unit 605 reproduces the entity data decoded by data decoding unit 604 (S58).

As a concrete example true of Case 3 shown in FIG. 15A, when it is possible to perform random access from any of samples like audio tracks, it is conceivable that there is a case where not storing the entry information in a track RA information storage box reduces the size of an RA information storage box. Also, as a concrete example true of Case 1 and 2 shown in FIG. 15A, it is conceivable that there is a case where restriction for disabling reading in the process of generating an RA information storage box is set. In this case, reproduction position controlling unit 607 outputs an order for moving reproduction positions to data file analyzing unit 603 by high-speed reproduction (S57). It is possible to have reproduction position controlling unit 607 skip outputting the order for changing reproduction positions and performing random access here because it is also possible to have the unit receive random access order after an RA information storage box is generated.

FIG. 15B is an illustration showing the second method for random access playback by moving picture data reproducing device 600 in the third embodiment.

This second method differs from the first method shown in FIG. 15A in the process by reproduction position controlling unit 607 in Cases 2 and 3.

In Case 2 shown in FIG. 15B, reproduction position controlling unit 607 judges that it is possible to perform random access from any of samples. Therefore, reproduction position controlling unit 607 outputs an order for moving a reproduction position to data file analyzing unit 603 so that the sample whose time is nearest to the time specified by the random access order can be regarded as the reproduction starting position.

Also, in Case 3 shown in FIG. 15B, reproduction position controlling unit 607 judges that it is impossible to perform random access from any of samples or it is possible to reproduce only from the sample at the head of the file concerning the track. Therefore, reproduction position controlling unit 607, for example, never receives input of a random access order from a user, or receives input of a random access order from a user only when moving to the head of a file, and only outputs an order for moving a reproduction position for moving to the head of the file to data file analyzing unit 603.

In this way, as moving picture data reproducing device 600 can alter the procedure of random access playback method responding to the presence or absence of an RA information storage box and so on, the components of a track RA information storage box or entry information can be freely set. Also, it is possible to flexibly cope with a trouble such that RA information cannot be extracted from an RA information storage box.

As explained up to this point, the moving picture data reproducing device in the third embodiment can generate and output boxes for storing RA information for respective tracks and a box for storing these boxes all in one, and thus the device can contribute to quickening random access playback. Also, it is possible to realize quick random access playback by performing it using RA information stored in these boxes.

(Fourth Embodiment)

Next, a fourth embodiment in the present invention will be explained.

Explanation for the moving picture data reproducing device for outputting a new MP4 file after adding an RA information storage box to the end of the MP4 file is made in the third embodiment mentioned above.

By contrast, the moving picture data reproducing device in the fourth embodiment also outputs an MP4 file that contains information for facilitating access to this RA information storage box. Therefore, the structure of the MP4 file outputted by the moving picture data reproducing device in the fourth embodiment differs from that of the MP4 file outputted by the moving picture data reproducing device in the third embodiment mentioned above. The difference will be focused on in the explanation below. As the components of the moving picture data reproducing device in the fourth embodiment are very similar to those of the moving picture data reproducing device in the third embodiment, FIG. 13 is used for a reference instead of a block diagram of this device.

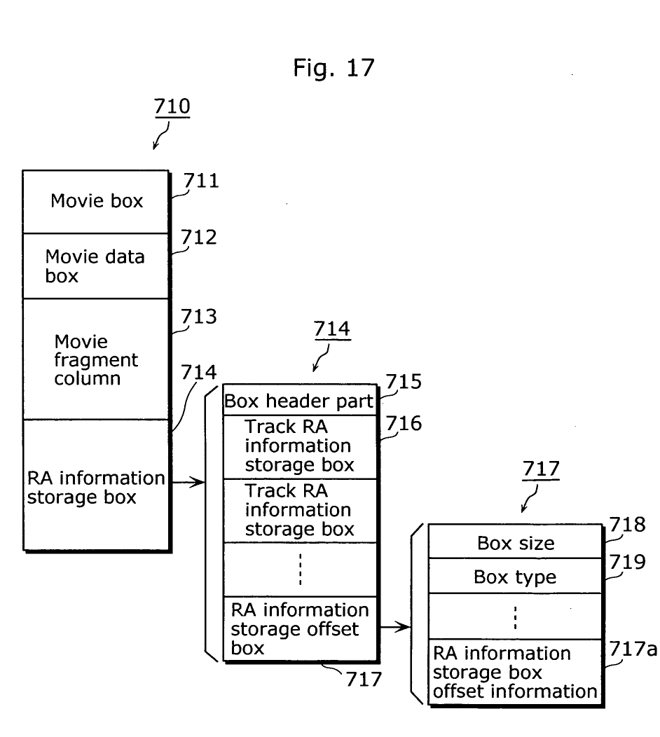

FIG. 17 is a diagram showing the file structure of the MP4 file generated by the moving picture data reproducing device in the fourth embodiment.

This MP4 file 710 is composed of movie box 711, movie data box 712, movie fragment box column 713 and RA information storage box 714. In this point, MP4 file 710 is the same as MP4 file 700 in the third embodiment mentioned above while MP4 file 710 differs from MP4 file 700 in that RA information storage box 714 of the MP4 file 710 includes RA information storage offset box 717.

The structure of this MP4 file 710 is also the same as that of the conventional MP4 file 100 at the stage of being inputted in the moving picture data reproducing device.

This RA information storage offset box 717 is a box for storing offset information of an RA information storage box for indicating the byte position from the head or the end of MP4 file 710 at which RA information storage box 714 starts from, and RA information storage offset box 717 contains a box header part and box data storage parts like other boxes consist of MP4 file 710.

The box header of this RA information storage offset box 717 contains at least a field of box size 718 for indicating size information of this box and a field of box type 719 for indicating letter strings of, for example, “mfro” as letter strings for indicating the box type of this box, and for example, 4 bytes is assigned to respective fields.

Also, the box data storage part of RA information storage offset box 717 contains a field of RA information storage box offset information 720 for writing offset information of an RA information storage box, and for example, 4 bytes is assigned to this field. Regarding this offset information 720 as size information of RA information storage box 714 enables the moving picture data reproducing device to read reversely from the end of MP4 file 710 to offset information 720 and to easily access RA information storage box 714. In other words, this offset information 720 “mfro” provides the size of RA information storage box 714 “mfra”. When this offset information 720 is placed last in the file, the moving picture data reproducing device is able to find the “mfra” box easily by scanning from the end of the file.

First, the outline of this RA information storage offset box 717 is generated, for example, when RA information storage box 714 in RA information storage box generating unit 606 is generated, and RA information storage offset box 717 is generated by information stored in a field inside the box when RA information storage box 714 is added to the end of the input MP4 file in file outputting unit 608.

There is a case where a field for indicating version information of this box and so on is stored in RA information storage offset box 717 next to the field of box type 719, but the fourth embodiment is a case where RA information storage offset box 717 contains three fields of box size 718, box type 719 and offset information 720, and the sizes of these fields are fixed as 12 bytes in total.

The procedure for having the moving picture data reproducing device in the fourth embodiment get RA information will be explained here.

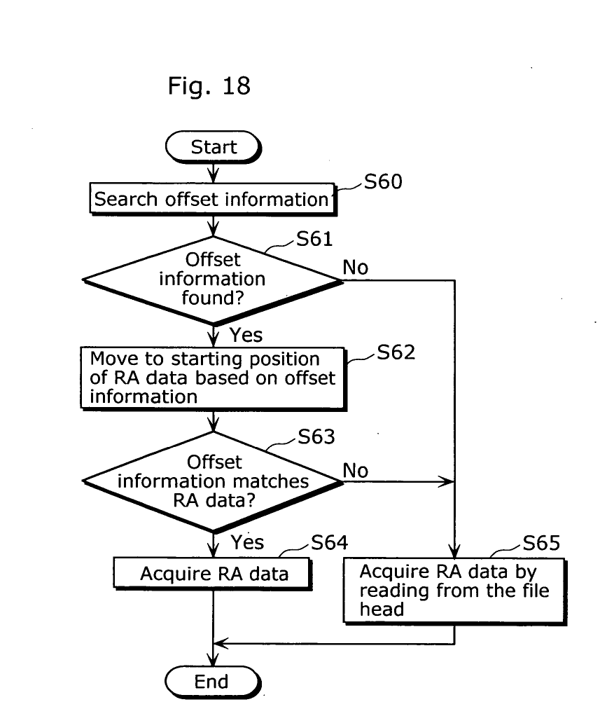

FIG. 18 is a flow chart showing the acquirement procedure of RA information by the moving picture data reproducing device in the fourth embodiment.

A moving picture data reproducing device usually acquires information stored in a box placed at the head of a file in order when reading an MP4 file, even when getting other information instead of RA information. On the other hand, a moving picture data reproducing device can also search the end of an MP4 file and acquire information stored in a box reversely from the end.

As RA information storage box 714 is placed at the end of MP4 file 710, the moving picture data reproducing device searches the box in which offset information of RA information storage box 714 is stored from the end of the MP4 file (S60).

In the case where a box in which offset information is stored, that is RA information storage offset box 717 and RA information storage box offset information 720 contained in the RA information storage offset box 717 are found here (S61), the moving picture data reproducing device moves the reading position to the starting position of RA data, that is the head of RA information storage box 714 based on the offset information (S62).

The moving picture data reproducing device judges whether the offset information matches the RA data or not, that is, the device tests the correctness of the offset information (S62). This time, the moving picture data reproducing device judges whether the file reading position changed by the offset information matches the starting position of RA information storage box 714. This test will be explained further with reference to figures later on.

Then the moving picture data reproducing device gets RA data stored in the box from the head of RA information storage box 714 in order (S64).

On the other hand, when RA information storage offset box 717 is not found, when RA information storage offset box 717 is found but RA information storage box offset information contained in the RA information storage offset box 717 is not found (S61), or when the offset information does not match the RA data (S63), the moving picture data reproducing device employs a usual information acquirement method of getting the information stored in the box placed in the head of the file in order, and the device gets RA data from RA information storage box 714 (S65).

The test on the correctness of the offset information mentioned above will be explained here with reference to figures.

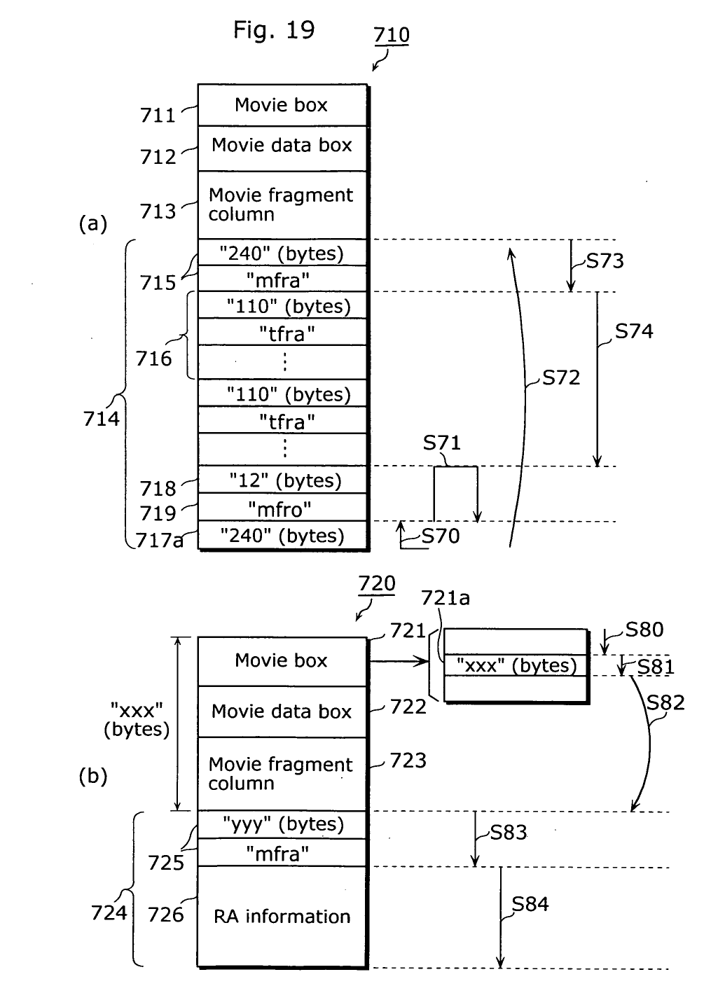

FIG. 19A is an illustration showing the first acquirement procedure of RA information by the moving picture data reproducing device in the fourth embodiment.

First, the moving picture data reproducing device searches the end of MP4 file 710 and gets the information stored in the box reversely from the end (S70).

In FIG. 19A, a piece of offset information of “240” bytes is stored in the field of RA information storage box offset information 720, but it is impossible to get an assurance that the number of “240” bytes is a piece of offset information of the RA information storage box at this stage. Therefore, the moving picture data reproducing device goes back further to acquire the information stored in the box (S71) and judges whether this number is a piece of offset information of an RA information storage box or not by a test.

As the fourth embodiment here is the case where the size of RA information storage offset box 717 is fixed 12 bytes in total, when the moving picture data reproducing device confirms that a piece of size information of “12” is stored in the field of box size 718 whose location is 12 bytes backward from the end of MP4 file 710, and that letter strings of “mfro” is stored in the field of box type 719, the moving picture data reproducing device judges that the following 4-byte-field is RA information storage box offset information 720.

In other words, the moving picture data reproducing device can decide that the previously acquired information of “240” bytes is a piece of offset information in an RA information storage at this stage.

Next, the moving picture data reproducing device follows this “240” bytes of offset information in an RA information storage box and changes the reading position to the position 240 bytes backward from the end of MP4 file 710 (S72).

After changing the reading position, the moving picture data reproducing device acquires the information stored in the box up to the end of MP4 file 710 (S73) and tests the correctness of the above-mentioned offset information.

When the moving picture data reproducing device acquires letter strings of “mfra” stored in the field of box header part 715 in RA information storage box 714 here, the moving picture data reproducing device judges that the box under reading is RA information storage box 714.

Next, the moving picture data reproducing device acquires the box size information stored in the field of the box header part of track RA information storage box 716 stored in RA information storage box 714 for each track RA information storage box 716. Two track RA information storage box 716 whose sizes are “110” bytes respectively are shown in FIG. 19A.

After that, the moving picture data reproducing device judges whether the total byte size of all the track RA information storage box 716 (“110” bytes+“110” bytes), previously acquired RA information storage offset box 717 (“12” bytes), and the assigned field of the box header part 715 in RA information storage box 714 (“4” bytes+“4” bytes) matches the box size information (“240” bytes) stored in the field of the box header part 715 in RA information storage box 714 or not.

The correctness of the offset information mentioned above is judged through these tests, and after passing these tests, the moving picture data reproducing device acquires RA information stored in RA information storage box 714 regarding the offset information as correct (S74).

By the way, as a place in which offset information of an RA information storage is stored, instead of storing the information in RA information storage offset box 717 mentioned above, for example, it is possible to store in the movie box that stores the header information of the whole MP4 file.

In this case, the acquirement procedure of random access information by the moving picture data reproducing device is as shown below.

FIG. 19B is an illustration showing the second acquirement procedure of RA information by the moving picture data reproducing device in the fourth embodiment.

First, the moving picture data reproducing device acquires the information stored in movie box 721 placed at the head of MP4 file 720 (S80). When the moving picture data reproducing device acquires information of “xxx” bytes stored in the field of RA information storage box offset information 721a stored in movie box 721 (S81), the moving picture data reproducing device moves the reading position to the place “xxx” bytes away from the head of MP4 file (S82).

After changing the reading position, the moving picture data reproducing device acquires the information stored in the box up to the end of MP4 file 720 (S83) and tests the correctness of the above-mentioned offset information.

When the moving picture data reproducing device acquires letter strings of “mfra” stored in the field of box header part 725 in RA information storage box 724 here, the moving picture data reproducing device decides that the box under reading is RA information storage box 724, and judges the correctness of the offset information mentioned above.

After passing these tests, the moving picture data reproducing device regards the offset information as correct, and acquires RA information 726 such as a track RA information storage box stored in RA information storage box 724 (S84).

In this way, as a place in which offset information of an RA information storage box is stored, movie box 721 can also be used.

As explained up to this point, as the moving picture data reproducing device in the fourth embodiment generates and outputs offset information that indicates the starting position of an RA information box, it is possible to quicken reading an RA information storage box by using this offset information, and thus it is possible to realize quick random access playback.

### APPLIED EXAMPLE

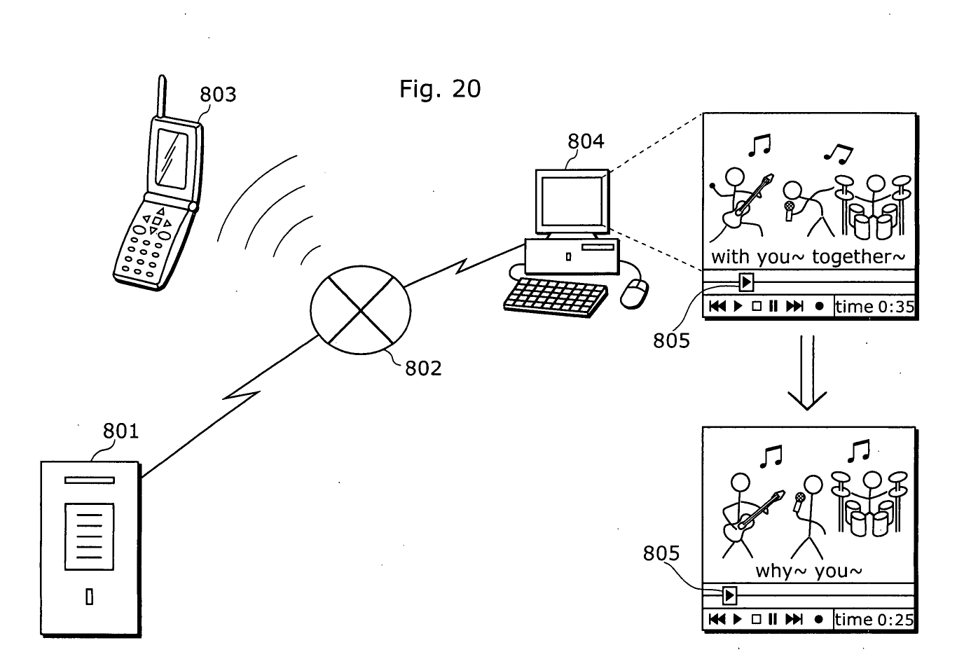

An applied example in the present invention will be explained here with reference to FIG. 20.

FIG. 20 is a diagram showing the applied example for the moving picture data reproducing device in the present invention.

The moving picture data reproducing device in the present invention can be used for a moving picture distribution system capable of sending and receiving an MP4 file via a communication line such as the Internet and so on.

As shown in FIG. 20, this moving picture distribution system is composed of server 801, communication network 802, cellular phone 803, and personal computer 804.

Here, cellular phone 803 and personal computer 804 are corresponding to the moving picture data reproducing device in the present invention.

In other words, cellular phone 803 or personal computer 804 downloads an MP4 file from server device 801 that distributes an MP4 file in which video data, audio data and so on are multiplexed via communication network 802.

As shown in FIG. 20, an MP4 file reproducible by personal computer 804 contains multiplexed video data, audio data and text data, and personal computer 804 reproduces this MP4 file while downloading it and displays a moving picture under reproduction on a display.

At this time, personal computer 804 downloads the MP4 file from the head in order, temporarily stores the file in the memory or the hard disc built into personal computer 804 itself, generates RA information from the header information stored in a memory and the like using a CPU and so on, and generates an RA information table or an RA information storage box by integrating the RA information into the RA information table or the RA information storage box.

At the same time, personal computer 804 stores the header information of the whole MP4 file and RA information to be generated in order in a memory and the like while reproducing the MP4 file.

Here, for example, when a user slides bar 805 placed in the lower part of the display to the left using a mouse and the like, that is, when a user executes an operation of reversing the reproduction position, personal computer 804 can perform quick random access, start reproducing the moving picture from the position of the bar after moving, and display the moving picture on the display by referring to the header information of the whole MP4 file and the generated RA information.

In this way, for example, the present invention can be realized in a moving picture distribution system, as this moving picture data reproducing device generates information for performing quick random access playback and performs random access playback using this information, a user can enjoy a reproduced moving picture without feeling any stress.

To provide additional information here, in the case where personal computer 804 reads and reproduces the MP4 file that already contains an RA information storage box from a storage medium like a CD-ROM and so on, personal computer 804 reads the movie box that stores the header information of the whole MP4 file and the RA information storage box first and stores these boxes in a memory as they are while reproducing the MP4 file. After that, when receiving a random access order from a user, personal computer 804 performs quick random access like the way mentioned above by referring to and analyzing these boxes contained in a memory and the like or referring to the gotten information as an analysis result of these boxes contained in a memory and the like.

Explanations for the moving picture data reproducing device in the present invention are made based on respective embodiments and so on up to this point, this invention is not limited to these embodiments and so on.

For example, an MP4 file is explained as a moving picture file to be inputted in the moving picture data reproducing device in the respective embodiments mentioned earlier, but another kind of file such as the MPEG-2 transport stream file and the like can replace the MP4 file.

Also, an MP4 file is inputted in the moving picture data reproducing device by download in the respective embodiments mentioned earlier, but the MP4 file can be inputted in the moving picture data reproducing device by reading a recording medium such as a magneto-optic disc that stores the MP4 file.

And, when RA information storage tables and an RA information storage box are outputted being integrated into an MP4 file, RA information storage tables and an RA information storage box are added to the end of the MP4 file in the respective embodiments mentioned earlier, but the place for adding them is not limited to the above-mentioned places, for example, RA information table can be stored in a movie box.

In addition, byte numbers assigned to respective fields that compose RA information are specified as fixed length in the respective embodiments mentioned earlier, but respective fields can be specified as variable length flexibly responding to the size of MP4 file. For example, adding a field for specifying byte lengths of respective fields to the data structure shown in FIG. 5, makes it possible to choose bit lengths of 1˜4 bytes for these respective fields for “traf” number, “trun” number, and “entry” number, and also, to assign 2 bytes to each field when the size of an MP4 file is big.

### INDUSTRIAL APPLICABILITY

The moving picture data reproducing device in the present invention can be used as a reproducing device that can read a file in which video data, audio data and the like are multiplexed, especially as a personal computer or a cellular phone that can be a receiving and reproducing device in a moving picture distribution system.

1. A moving picture data reproducing device for reproducing a file in which video data and at least one of audio data and text data are multiplexed, the moving picture data reproducing device comprising:
a file inputting unit operable to acquire the file;
a file temporary storage unit that has an area for temporarily storing an input file acquired by the file inputting unit;
a file analyzing unit operable to read the input file and analyze a file header information for separation and synchronous reproduction of the video data, audio data, or text data contained in the input file;
a decoding unit operable to read and decode the video data, audio data or text data contained in the input file stored in the file temporary storage unit, based on the file header information analyzed by the file analyzing unit;
a reproducing unit operable to reproduce the video data, audio data or text data decoded by the decoding unit and output the data to a displaying device;
a random access information generating unit operable to generate random access information for random access to the video data, audio data or text data contained in the input file based on the file header information analyzed by the file analyzing unit;
a reproduction position controlling unit operable to output, to the file analyzing unit, an analysis position change order for changing an analysis position of the input file with reference to the random access information generated by the random access information generating unit, and
wherein the file analyzing unit changes a reading position of the input file stored in the file temporary storage unit based on the analysis position change order outputted by the reproduction position controlling unit, and, from the after-change reading position, analyzes the file header information of the video data, audio data or text data contained in the input file.

2. The moving picture data reproducing device according to claim 1,
wherein the random access information is position information for reading the file header information on an intra frame of the moving picture data contained in the input file.

3. The moving picture data reproducing device according to claim 2,
wherein the position information for reading the file header information is the ID numbers indicating the position of the file header information when the input file has a hierarchical structure and an ID number is assigned to each hierarchical structure.

4. The moving picture data reproducing device according to claim 2,
wherein the random access information further comprises information on reproduction time of the intra frame.

5. The moving picture data reproducing device according to claim 2,
wherein the random access information further comprises information on a starting position of the intra frame.

6. The moving picture data reproducing device according to claim 2,
wherein the random access information comprises a plurality of position information for reading the file header information.

7. The moving picture data reproducing device according to claim 1,
wherein the random access information generating unit generates the random access information for respective media data of video data, audio data and text data contained in the input file.

8. The moving picture data reproducing device according to claim 7,
wherein, when the random access information is concerning the audio data contained in the input file, the random access information contains a plurality of position information for reading the file header information on the audio data frames according to a prescribed rule.

9. The moving picture data reproducing device according to claim 8,
wherein, the random access information contains a plurality of position information for reading the file header information on the audio data frames with reproduction time nearest to the reproduction time of the intra frame of the video data contained in the input file.

10. The moving picture data reproducing device according to claim 1, the moving picture data reproducing device further comprising:
a file outputting unit operable to output a file which contains the random access information generated by the random access information generating unit.

11. The moving picture data reproducing device according to claim 10,
wherein, when the input file has a hierarchical structure, the random access information generating unit generates a first hierarchical layer for writing the random access information for respective media data contained in the input file and a second hierarchical layer in which the first hierarchical layer is integrated, and
the file outputting unit outputs the file which contains the random access information by integrating the second hierarchical layer into the input file.

12. The moving picture data reproducing device according to claim 11,
wherein the file outputting unit generates the position information indicating the starting position of the second hierarchical layer integrated into the input file, integrates the position information into the input file, and outputs the file with the random access information.

13. The moving picture data reproducing device according to claim 12,
wherein position information indicating the starting position of the second hierarchical layer is stored in the end of the second hierarchical layer.

14. The moving picture data reproducing device according to claim 13,
wherein position information indicating the starting position of the second hierarchical layer is the byte size of the second hierarchical layer.

15. The moving picture data reproducing device according to claim 14,
wherein the reproduction position controlling unit moves a reading position with reference to position information indicating the starting position of the second hierarchical layer, and acquires the random access information.

16. The moving picture data reproducing device according to claim 15,
wherein the reproduction position controlling unit moves the reading position with reference to the position information indicating the starting position of the second hierarchical layer, confirms that the reading position is the starting position of the second hierarchical layer, and then acquires the random access information.

17. The moving picture data reproducing device according to claim 12,
wherein position information indicating the starting position of the second hierarchical layer is stored in a field for writing the file header information.

18. The moving picture data reproducing device according to claim 11,
wherein the file outputting unit places the second hierarchical layer to the end of the input file, and integrates the second hierarchical layer into the input file.

19. The moving picture data reproducing device according to claim 11,
wherein the reproduction position controlling unit judges whether the input file contains the second hierarchical layer, the first hierarchical layer, and the random access information or not,
when the second hierarchical layer is not contained or the second hierarchical layer is contained but the first hierarchical layer is not contained, the reproduction position controlling unit does not output the analysis position change order, and
when the first and the second hierarchical layers are contained, the reproduction position controlling unit outputs the analysis position change order.

20. The moving picture data reproducing device according to claim 10,
wherein the file outputting unit multiplexes the random access information generated by the random access information generating unit into the input file stored in the file temporary storing unit, and outputs a file that contains the random access information.

21. The moving picture data reproducing device according to claim 10,
wherein the file outputting unit outputs a file that contains the random access information generated by the random access information generating unit, the input file stored in the file temporary storage unit, and a file that contains association information of the file with the random access information and the input file.

22. The moving picture data reproducing method for reproducing a file in which video data and at least one of audio data and text data are multiplexed, the moving picture data reproducing method comprising:
a file inputting step for acquiring the file;
a file temporary storage step for storing the acquired input file in a storage area for temporary storage in the file inputting step;
a file analyzing step for reading the input file contained in the storage area and analyzing the file header information for separation and synchronous reproduction of the video data, audio data, or text data contained in the input file;
a decoding step for reading and decoding the video data, audio data or text data contained in the input file stored in the storage area based on the analyzed file header information in the file analyzing step;
a reproducing step for reproducing the decoded video data, audio data or text data and outputting the data to a displaying device in the decoding step;
a random access information generating step for generating random access information in order to perform random access to the video data, audio data or text data contained in the input file based on the analyzed file header information in the file analyzing step; and
a reproduction position controlling step for outputting, to the file analyzing step, an analysis position change order for ordering that analysis position of the input file should be changed with reference to the random access information generated in the random access information generating step,
wherein in the file analyzing step, based on the analysis position change order outputted in the reproduction position controlling step, the reading position of the input file stored in the storage area is changed, and the file header information of the video data, audio data or text data contained in the input file is analyzed.

23. The moving picture data reproducing method according to claim 22, the moving picture data reproducing method further comprising:
a file outputting step for outputting a file that contains the random access information generated in the random access information step.

24. The moving picture data reproducing method according to claim 23,
wherein in the random access information generating step, when the input file has a hierarchical structure, a first hierarchical layer for writing the random access information for respective media data contained in the input file and a second hierarchical layer into which the first hierarchical layer integrated are generated, and
in the file outputting step, the second hierarchical layer is integrated into the input file, and a file that contains the random access information is outputted.

25. The moving picture data reproducing method according to claim 24,
wherein in the file outputting step, position information indicating the starting position of the second hierarchical layer which is integrated into the input file is generated, the position information is integrated into the input file, and a file that contains the random access information is outputted.

26. The moving picture data reproducing method according to claim 25,
wherein in the reproduction position controlling step, a reading position is moved with reference to position information indicating the starting position of the second hierarchical layer, and the random access information is acquired.

27. The moving picture data reproducing method according to claim 22,
wherein the random access information generated in the random access information generating step is position information for reading the file header information on an intra frame of the video data contained in the input file.

28. The moving picture data reproducing method according to claim 22,
wherein in the random access information generating step,
the random access information for respective media data contained in the input file is generated.

29. A program for a moving picture data reproducing device, the program comprising:
a file inputting step for acquiring a file in which video data and at least one of audio data and text data are multiplexed;
a file temporary storage step for temporarily storing the acquired input file in a storage area for temporary storage in the file inputting step;
a file analyzing step for reading the input file contained in the storage area and analyzing the file header information for separation and synchronous reproduction of the video data, audio data, or text data contained in the input file;
a decoding step for reading and decoding the video data, audio data or text data contained in the input file stored in the storage area based on the analyzed file header information in the file analyzing step;
a reproducing step for reproducing the decoded video data, audio data or text data and outputting the data to a displaying device in the decoding step;
a random access information generating step for generating random access information in order to perform random access to the video data, audio data or text data contained in the input file based on the analyzed file header information in the file analyzing step; and
a reproduction position controlling step for outputting an analysis position change order for ordering that analysis position of the input file should be changed to the file analyzing step with reference to the random access information generated in the random access information generating step,
wherein in the file analyzing step, based on the analysis position change order outputted in the reproduction position controlling step, the reading position of the input file stored in the storage area is changed, and the file header information of the video data, audio data or text data contained in the input file is analyzed.

30. A storage medium that stores a computer readable file in the storage medium, the file comprising:
at least one of media data of video data, audio data and text data;
header information for separation and synchronous reproduction of the media data; and
random access information into which position information of the header information on individually decodable frames of frames that constitute the media data is integrated.

31. A storage medium according to claim 30, the file further comprising:
two or more media data of the media data; and
the random access information corresponding to those media data respectively.

32. A storage medium according to claim 31, the file with a hierarchical structure comprising:
the first hierarchical layer for writing the random access information for the respective media data and the second hierarchical layer into which the first hierarchical layer is integrated; and
position information indicating the starting position of the second hierarchical layer.
